(19) United States
(12) Patent Application Publication
(10) Pub. No.: US 2024/0353652 A1
(43) Pub. Date: Oct. 24, 2024

(54) IMAGING LENS AND IMAGING APPARATUS

(71) Applicant: FUJIFILM Corporation, Tokyo (JP)

(72) Inventors: Yuya HIRAKAWA, Saitama (JP); Masato KONDO, Saitama (JP); Shunsuke MIYAGISHIMA, Saitama (JP); Yasutaka SHIMADA, Saitama (JP)

(73) Assignee: FUJIFILM Corporation, Tokyo (JP)

(21) Appl. No.: 18/638,523

(22) Filed: Apr. 17, 2024

(30) Foreign Application Priority Data
Apr. 24, 2023 (JP) 2023-071117

(51) Int. Cl. G02B 9/12

(52) U.S. Cl. CPC G02B 9/12

(57) ABSTRACT

An imaging lens consists of, in order from the object side to the image side, a first lens group, a stop, a second lens group, and a third lens group. At least a spacing between the second lens group and the third lens group changes during focusing. The number of lenses included in the imaging lens is equal to or greater than 7 and equal to or less than 10. The imaging lens satisfies predetermined conditional expressions.

### CROSS-REFERENCE TO RELATED APPLICATIONS

This application claims priority from Japanese Patent Application No. 2023-071117, filed on Apr. 24, 2023, the entire disclosure of which is incorporated herein by reference.

### BACKGROUND

### Technical Field

A technique of the present disclosure relates to an imaging lens and an imaging apparatus.

### Related Art

In the related art, as a imaging lens that can be used in an imaging apparatus such as a digital camera, a imaging lens described in JP2013-137377A below is known.

### SUMMARY

There is a demand for an imaging lens which has a small size and maintains favorable optical performance. The demand levels are increasing year by year.

An object of the present disclosure is to provide an imaging lens, which has a small size and maintains favorable optical performance, and an imaging apparatus comprising the imaging lens.

According to a first aspect of the present disclosure, an imaging lens consists of, in order from an object side to an image side: a first lens group; a stop; a second lens group; and a third lens group. At least a spacing between the second lens group and the third lens group changes during focusing, the number of lenses included in a whole system is equal to or greater than 7 and equal to or less than 10, and assuming that a sum of a back focal length of the whole system in terms of an air-equivalent distance and a distance on an optical axis from a lens surface closest to the object side in the first lens group to a lens surface closest to the image side in the third lens group in a state where an infinite distance object is in focus is TL, a focal length of the whole system in a state where the infinite distance object is in focus is f, a maximum half angle of view in a state where the infinite distance object is in focus is @, and the back focal length of the whole system in terms of the air-equivalent distance in a state where the infinite distance object is in focus is Bf, Conditional Expressions (1) and (2) are satisfied, which are represented by

$$\begin{matrix}0.6 < TL / ( f \times tan ω ) < 3 , and & ( 1 ) \\ 0.06 < Bf / ( f \times tan ω ) < 0.9 . & ( 2 )\end{matrix}$$

According to a second aspect of the present disclosure, in the imaging lens according to the first aspect, assuming that a focal length of the first lens group is f1, and a composite focal length of the second lens group and the third lens group in a state where the infinite distance object is in focus is f23, it is preferable that Conditional Expression (3) is satisfied, which is represented by

$$- 1 < f 1 / f 23 < 0.1 . \qquad ( 3 )$$

According to a third aspect of the present disclosure, in the imaging lens according to the second aspect, it is preferable that the first lens group, the stop, and the second lens group move integrally during focusing.

According to a fourth aspect of the present disclosure, in the imaging lens according to the third aspect, it is preferable that the first lens group includes, successively in order from a position closest to the object side, a negative lens of which a surface on the object side is convex, and a positive lens.

According to a fifth aspect of the present disclosure, in the imaging lens according to the first aspect, it is preferable that Conditional Expression (1-1) is satisfied, which is represented by

$$0.85 < TL / ( f \times tan ω ) < 2.1 . \qquad ( 1 - 1 )$$

According to a sixth aspect of the present disclosure, in the imaging lens according to the fifth aspect, it is preferable that Conditional Expression (2-1) is satisfied, which is represented by

$$0.1 < Bf / ( f \times tan ω ) < 0.51 . \qquad ( 2 - 1 )$$

According to a seventh aspect of the present disclosure, in the imaging lens according to the first aspect, assuming that a focal length of the first lens group is f1, it is preferable that Conditional Expression (4) is satisfied, which is represented by

$$- 0.5 < f / f 1 < 2.5 . \qquad ( 4 )$$

According to an eighth aspect of the present disclosure, in the imaging lens according to the first aspect, it is preferable that Conditional Expression (5) is satisfied, which is represented by

$$0 < TL / f < 1.7 . \qquad ( 5 )$$

According to a ninth aspect of the present disclosure, in the imaging lens according to the first aspect, it is preferable that the first lens group consists of a cemented lens in which a negative lens, of which an object side surface is convex, and a positive lens are cemented in order from the object side.

According to a tenth aspect of the present disclosure, it is preferable that the imaging lens according to the first aspect comprises a positive lens at a position closest to the image side in the third lens group.

According to an eleventh aspect of the present disclosure, in the imaging lens of the first aspect, assuming that a distance on the optical axis from a paraxial exit pupil position to an image plane in a state where the infinite distance object is in focus is Dexp, and Dexp is calculated using an air-equivalent distance for an optical member having no refractive power in a case where the optical member is disposed between the image plane and the paraxial exit pupil position, it is preferable that Conditional Expression (6) is satisfied, which is represented by

$$0.8 < Dexp / ( f \times tan ω ) < 2. \qquad ( 6 )$$

According to a twelfth aspect of the present disclosure, in the imaging lens according to the first aspect, assuming that a composite focal length of the first lens group and the second lens group in a state where the infinite distance object is in focus is f12, it is preferable that Conditional Expression (7) is satisfied, which is represented by

$$0.5 < f / f 12 < 1.5 . \qquad ( 7 )$$

According to a thirteenth aspect of the present disclosure, in the imaging lens according to the first aspect, it is preferable that a lens surface closest to the object side in the second lens group is concave, and a lens surface closest to the image side in the second lens group is convex.

According to a fourteenth aspect of the present disclosure, in the imaging lens according to the first aspect, it is preferable that the second lens group includes an aspherical lens at a position closest to the image side. Assuming that a distance on the optical axis from the stop to a lens surface closest to the image side in the second lens group in a state where the infinite distance object is in focus is dS2r, it is preferable that Conditional Expression (8) is satisfied, which is represented by

$$0.5 < dS 2 r / ( f \times tan ω ) < 1.5 . \qquad ( 8 )$$

According to a fifteenth aspect of the present disclosure, in the imaging lens according to the fourteenth aspect, assuming that a distance on the optical axis from the stop to a lens surface closest to the object side in the second lens group in a state where the infinite distance object is in focus is dS2f, and a paraxial curvature radius of a lens surface closest to the object side in the second lens group is R2f, it is preferable that Conditional Expression (9) is satisfied, which is represented by

$$- 0.5 < dS 2 r / R 2 f < 0. \qquad ( 9 )$$

According to a sixteenth aspect of the present disclosure, in the imaging lens according to the ninth aspect, assuming that a refractive index of the positive lens of the first lens group at a d line is N1p, a refractive index of the negative lens of the first lens group at the d line is N1n, an Abbe number of the positive lens of the first lens group based on the d line is v1p, an Abbe number of the negative lens of the first lens group based on the d line is v1n, a partial dispersion ratio of the positive lens of the first lens group between a g line and an F line is θgF1p, and a partial dispersion ratio of the negative lens of the first lens group between the g line and the F line is θgF1n, it is preferable that Conditional Expressions (10), (11), and (12) are satisfied, which are represented by

$$\begin{matrix}0 < N 1 p - N 1 n < 0.25 , & ( 10 ) \\ 0 < v 1 p - v 1 n < 40 , and & ( 11 ) \\ - 0.07 < θ gF 1 p - θ gF 1 n < 0. & ( 12 )\end{matrix}$$

According to a seventeenth aspect of the present disclosure, in the imaging lens according to the first aspect, it is preferable that the third lens group consists of, in order from the object side to the image side, a negative lens and a positive lens.

According to an eighteenth aspect of the present disclosure, in the imaging lens according to the first aspect, assuming that a focal length of the first lens group is f1, and a focal length of the third lens group is f3, it is preferable that Conditional Expression (13) is satisfied, which is represented by

$$- 11 < f 1 / f 3 < 7.5 . \qquad ( 13 )$$

According to a nineteenth aspect of the present disclosure, in the imaging lens of the first aspect, assuming that a distance on the optical axis from a lens surface closest to the object side in the first lens group to a lens surface closest to the image side in the second lens group in a state where the infinite distance object is in focus is DG12, it is preferable that Conditional Expression (14) is satisfied, which is represented by

$$0.5 < DG 12 / ( f \times tan ω ) < 2. \qquad ( 14 )$$

According to a twentieth aspect of the present disclosure, an imaging apparatus comprises the imaging lens according to any one of the first to nineteenth aspects.

In the present specification, it should be noted that the terms “consisting of” and “consists of” mean that the lens may include not only the above-mentioned constituent elements but also lenses substantially having no refractive powers, optical elements, which are not lenses, such as a stop, a filter, and a cover glass, and mechanism parts such as a lens flange, a lens barrel, an imaging element, and a camera shaking correction mechanism.

The term “group that has a positive refractive power” in the present specification means that the group has a positive refractive power as a whole. Similarly, the term “group that has a negative refractive power” means that the group has a negative refractive power as a whole. Each of the “first lens group”, the “second lens group”, and the “third lens group”, in the present specification is not limited to a configuration consisting of a plurality of lenses, but may have a configuration consisting of only one lens.

The term “a single lens” means one lens that is not cemented. Here, a compound aspherical lens (in which a lens (for example, a spherical lens) and an aspherical film formed on the lens are integrally formed and function as one aspherical lens as a whole) is not regarded as cemented lenses, but the compound aspherical lens is regarded as one lens. The curvature radius, the sign of the refractive power, and the surface shape of the lens including the aspherical surface will be used in terms of the paraxial region unless otherwise specified. The sign of the curvature radius of the surface convex toward the object side is positive, and the sign of the curvature radius of the surface convex toward the image side is negative.

The term “the whole system” of the present specification means an imaging lens. The “focal length” used in a conditional expression is a paraxial focal length. Unless otherwise specified, the “distance on the optical axis” used in Conditional Expression is considered as a geometrical distance. The values used in the conditional expressions are values in a case where the d line is used as a reference in a state where the infinite distance object is in focus unless otherwise specified.

According to the present disclosure, it is possible to provide an imaging lens which has a small size and maintains favorable optical performance, and an imaging apparatus comprising the imaging lens.

### BRIEF DESCRIPTION OF THE DRAWINGS

FIG. 1 is a cross-sectional view showing a configuration of an imaging lens according to an embodiment, which corresponds to an imaging lens of Example 1.

FIG. 2 is a cross-sectional view showing a configuration and a luminous flux of the imaging lens of Example 1, and is a diagram for explaining symbols of conditional expressions.

FIG. 3 is a diagram showing aberrations of the imaging lens of Example 1.

FIG. 4 is a cross-sectional view showing a configuration of an imaging lens of Example 2.

FIG. 5 is a diagram showing aberrations of the imaging lens of Example 2.

FIG. 6 is a cross-sectional view showing a configuration of an imaging lens of Example 3.

FIG. 7 is a diagram showing aberrations of the imaging lens of Example 3.

FIG. 8 is a cross-sectional view showing a configuration of an imaging lens of Example 4.

FIG. 9 is a diagram showing aberrations of the imaging lens of Example 4.

FIG. 10 is a cross-sectional view showing a configuration of an imaging lens of Example 5.

FIG. 11 is a diagram showing aberrations of the imaging lens of Example 5.

FIG. 12 is a cross-sectional view showing a configuration of an imaging lens of Example 6.

FIG. 13 is a diagram showing aberrations of the imaging lens of Example 6.

FIG. 14 is a cross-sectional view showing a configuration of an imaging lens of Example 7.

FIG. 15 is a diagram showing aberrations of the imaging lens of Example 7.

FIG. 16 is a cross-sectional view showing a configuration of an imaging lens of Example 8.

FIG. 17 is a diagram showing aberrations of the imaging lens of Example 8.

FIG. 18 is a cross-sectional view showing a configuration of an imaging lens of Example 9.

FIG. 19 is a diagram showing aberrations of the imaging lens of Example 9.

FIG. 20 is a perspective view of the front side of the imaging apparatus according to an embodiment.

FIG. 21 is a perspective view of the rear side of the imaging apparatus according to the embodiment.

### DESCRIPTION OF EMBODIMENTS

Hereinafter, embodiments of the present disclosure will be described with reference to the accompanying drawings.

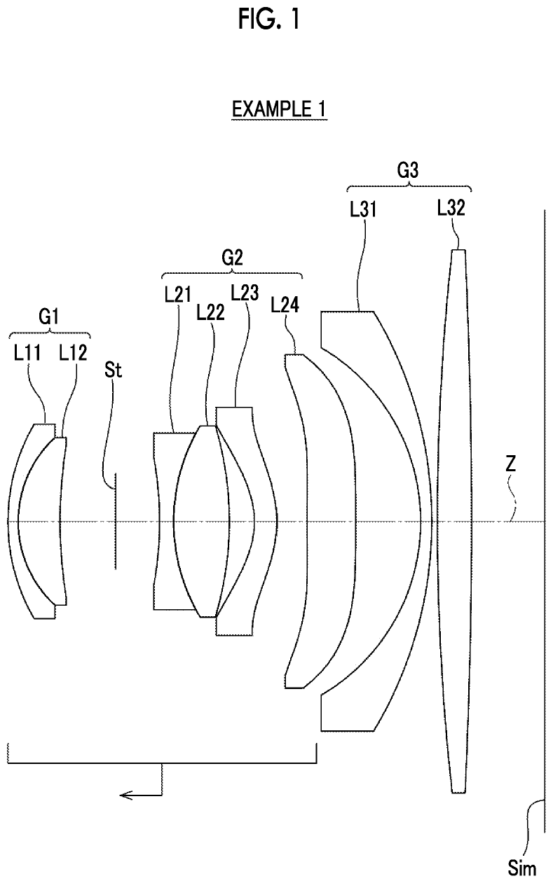

FIG. 1 is a cross-sectional view showing a configuration of an imaging lens according to an embodiment of the present disclosure. FIG. 1 shows a state where an infinite distance object is in focus, in which the left side thereof is an object side, and the right side thereof is an image side. In the present specification, an object at a distance of infinity is referred to as the infinite distance object. The example shown in FIG. 1 corresponds to the imaging lens according to Example 1 to be described later.

The imaging lens of the present disclosure consists of, in order from the object side to the image side along the optical axis Z, a first lens group G1, an aperture stop St, a second lens group G2, and a third lens group G3. At least a spacing between the second lens group G2 and the third lens group G3 changes during focusing. With such a configuration, it is possible to support both focus methods of front focus and inner focus.

The imaging lens of the present disclosure is configured such that the number of lenses included in the whole system is equal to or greater than 7 and equal to or less than 10. By setting the number of lenses included in the imaging lens to 7 or more, there is an advantage in suppressing various aberrations. By setting the number of lenses to 10 or less, there is an advantage in reducing the total length thereof.

For example, the lens groups of the imaging lens of FIG. 1 are configured as follows. The first lens group G1 consists of two lenses L11 and L12, in order from the object side to the image side. The second lens group G2 consists of four lenses L21 to L24, in order from the object side to the image side. The third lens group G3 consists of two lenses L31 and L32, in order from the object side to the image side. It should be noted that the aperture stop St in FIG. 1 does not indicate a size and a shape, but indicates a position in an optical axis direction.

In the example of FIG. 1, the first lens group G1, the aperture stop St, and the second lens group G2 move integrally during focusing. With such a configuration, there is an advantage in reducing fluctuation in aberration due to fluctuation in object distance. It should be noted that, in the present specification, the term “move integrally” means moving by the same amount in the same direction at the same time. The parentheses and the left-pointing arrow below the first lens group G1, the aperture stop St, and the second lens group G2 in FIG. 1 indicate moving to the object side during focusing from the infinite distance object to the closest object.

In the imaging lens of the present disclosure, it is preferable that the first lens group G1 includes, successively in order from the position closest to the object side, a negative lens of which an object side surface is convex and a positive lens. In such a case, there is an advantage in correcting field curvature, and there is an advantage in reducing the sensitivity of optical performance with respect to manufacturing errors.

The first lens group G1 may be configured to consist of a cemented lens in which a negative lens, of which an object side surface is convex, and a positive lens are cemented in order from the object side. In such a case, there is an advantage in reducing chromatic aberration. Further, by adopting the configuration in which the first lens group G1 consists of two lenses, there is an advantage in reducing the size.

The lens surface closest to the object side in the second lens group G2 may be configured to be concave, and the lens surface closest to the image side in the second lens group G2 may be configured to be convex. In such a case, there is an advantage in correcting off-axis aberrations, and there is an advantage in reducing the sensitivity of optical performance with respect to manufacturing errors.

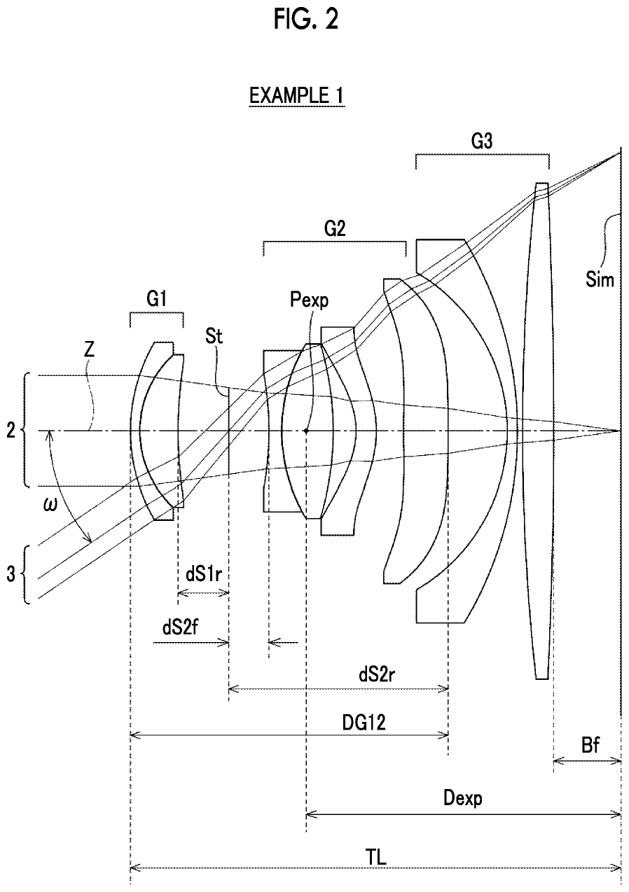

It is preferable that the second lens group G2 includes an aspherical lens at a position closest to the image side. The on-axis ray and the off-axis ray are separated in the lens closest to the image side in the second lens group G2. Therefore, by using the lens as an aspherical lens, it is possible to increase the effect of correcting aberrations of the aspherical surface. FIG. 2 is a cross-sectional view of a configuration and luminous flux of the imaging lens of FIG. 1. FIG. 2 shows, as the luminous flux, an on-axis luminous flux 2 and a luminous flux 3 with a maximum half angle of view @.

The third lens group G3 may be configured to include a positive lens at the position closest to the image side. In such a case, there is an advantage in reducing an angle of incidence of a principal ray onto an image plane Sim.

The third lens group G3 may be configured to consist of, in order from the object side to the image side, a negative lens and a positive lens. In such a case, there is an advantage in reducing the angle of incidence of the principal ray on the image plane Sim while making the imaging lens compatible with a large-sized imaging element.

Hereinafter, preferable configurations of the imaging lens of the present disclosure relating to conditional expressions will be described. In the following description of conditional expressions, in order to avoid redundancy, the same symbol is used for the same definition, and the duplicate description of the symbol is omitted. Further, in the following description of the conditional expressions, the “imaging lens of the present disclosure” is simply referred to as an “imaging lens” in order to avoid redundancy.

It is preferable that the imaging lens satisfies Conditional Expression (1). Here, it is assumed that a sum of the back focal length of the whole system in terms of the air-equivalent distance and a distance on the optical axis from a lens surface closest to the object side in the first lens group G1 to a lens surface closest to the image side in the third lens group G3 in a state where the infinite distance object is in focus is TL. It is assumed that a focal length of the whole system in a state where the infinite distance object is in focus is f. It is assumed that a maximum half angle of view in a state where the infinite distance object is in focus is @. TL is a total optical length in a state where the infinite distance object is in focus. For example, FIG. 2 shows the above-mentioned total optical length TL and the maximum half angle of view w in the imaging lens of FIG. 1. The tan of Conditional Expression (1) is a tangent, and this notation is the same for other conditional expressions. By not allowing a corresponding value of Conditional Expression (1) to be equal to or less than the lower limit thereof, the spacing can be set to be advantageous for aberration correction and the workability of the lens. By not allowing the corresponding value of Conditional Expression (1) to be equal to or greater than the upper limit thereof, there is an advantage in reducing the total length thereof.

$$0.6 < TL / ( f \times tan ω ) < 3 \qquad ( 1 )$$

In order to obtain more favorable characteristics, it is preferable to set any one of 0.7, 0.75, 0.8, 0.85, 0.9, 0.95, or 1 instead of 0.6 which is the lower limit of Conditional Expression (1). Further, it is preferable to set any one of 2.7, 2.4, 2.2, 2.1, 2, 1.9, or 1.85 instead of 3 which is the upper limit of Conditional Expression (1). For example, it is more preferable that the imaging lens satisfies Conditional Expression (1-1).

$$0.85 < TL / ( f \times tan ω ) < 2.1 \qquad ( 1 - 1 )$$

It is preferable that the imaging lens satisfies Conditional Expression (2). Here, it is assumed that the back focal length of the whole system in terms of the air-equivalent distance in a state where the infinite distance object is in focus is Bf. For example, FIG. 2 shows the back focal length Bf. By not allowing a corresponding value of Conditional Expression (2) to be equal to or less than the lower limit thereof, it is possible to ensure an interval between a part disposed around the imaging element in the imaging apparatus and the imaging lens. By not allowing the corresponding value of Conditional Expression (2) to be equal to or greater than the upper limit thereof, there is an advantage in reducing the total length thereof.

$$0.06 < Bf / ( f \times tan ω ) < 0.9 \qquad ( 2 )$$

In order to obtain more favorable characteristics, it is preferable to set any one of 0.07, 0.08, 0.09, or 0.1 instead of 0.06 which is the lower limit of Conditional Expression (2). Further, it is preferable to set any one of 0.8, 0.7, 0.6, or 0.51 instead of 0.9 that is the upper limit of Conditional Expression (2). For example, it is more preferable that the imaging lens satisfies Conditional Expression (2-1).

$$0.1 < Bf / ( f \times tan ω ) < 0.51 \qquad ( 2 - 1 )$$

It is preferable that the imaging lens satisfies Conditional Expression (3). Here, it is assumed that a focal length of the first lens group G1 is f1. It is assumed that a composite focal length of the second lens group G2 and the third lens group G3 in a state where the infinite distance object is in focus is f23. By not allowing a corresponding value of Conditional Expression (3) to be equal to or less than the lower limit thereof, there is an advantage in correcting aberrations, and there is an advantage in reducing the sensitivity of optical performance with respect to manufacturing errors. By not allowing the corresponding value of Conditional Expression (3) to be equal to or greater than the upper limit thereof, there is an advantage in reducing the total length thereof.

$$- 1 < f 1 / f 23 < 0.1 \qquad ( 3 )$$

In order to obtain more favorable characteristics, it is preferable to set any one of −0.8, −0.7, or −0.65 instead of −1 which is the lower limit of Conditional Expression (3). Further, it is preferable to set any one of 0.075, 0.05, or 0.035 instead of 0.1 which is the upper limit of Conditional Expression (3).

It is preferable that the imaging lens satisfies Conditional Expression (4). By not allowing a corresponding value of Conditional Expression (4) to be equal to or less than the lower limit thereof, there is an advantage in reducing the total length thereof. By not allowing the corresponding value of Conditional Expression (4) to be equal to or greater than the upper limit thereof, there is an advantage in correcting spherical aberration.

$$- 0.5 < f / f 1 < 2.5 \qquad ( 4 )$$

In order to obtain more favorable characteristics, it is preferable to set any one of −0.1, 0.3, 0.7, or 0.95 instead of −0.5 which is the lower limit of Conditional Expression (4). Further, it is preferable to set any one of 2.2, 2, 1.9, or 1.8 instead of 2.5 which is the upper limit of Conditional Expression (4).

It is preferable that the imaging lens satisfies Conditional Expression (5). Regarding the lower limit of Conditional Expression (5), since TL>0 and f>0, TL/f>0. By not allowing a corresponding value of Conditional Expression (5) to be equal to or greater than the upper limit thereof, there is an advantage in reducing the total length thereof.

$$0 < TL / f < 1.7 \qquad ( 5 )$$

In addition, in a case where the imaging lens satisfies TL/f>0.5, the spacing can be set to be advantageous for aberration correction and the workability of the lens. In order to obtain more favorable characteristics, it is preferable that the imaging lens satisfies TL/f>0.9. Further, it is preferable to set any one of 1.5 or 1.3 instead of 1.7 which is the upper limit of Conditional Expression (5).

It is preferable that the imaging lens satisfies Conditional Expression (6). Here, it is assumed that a distance on the optical axis from a paraxial exit pupil position Pexp to the image plane Sim in a state where the infinite distance object is in focus is Dexp. In addition, in a case where an optical member having no refractive power is disposed between the image plane Sim and the paraxial exit pupil position Pexp, Dexp is calculated using an air-equivalent distance for the optical member. For example, FIG. 2 shows the paraxial exit pupil position Pexp and the distance Dexp. By not allowing a corresponding value of Conditional Expression (6) to be equal to or less than the lower limit thereof, there is an advantage in reducing the angle of incidence of the principal ray onto the image plane Sim. By not allowing the corresponding value of Conditional Expression (6) to be equal to or greater than the upper limit thereof, there is an advantage in reducing the total length thereof.

$$0.8 < Dexp / ( f \times tan ω ) < 2 \qquad ( 6 )$$

In order to obtain more favorable characteristics, it is preferable to set any one of 0.9 or 1 instead of 0.8 which is the lower limit of Conditional Expression (6). Further, it is preferable to set any one of 1.75 or 1.55 instead of 2 which is the upper limit of Conditional Expression (6).

It is preferable that the imaging lens satisfies Conditional Expression (7). Here, it is assumed that a composite focal length of the first lens group G1 and the second lens group G2 in a state where the infinite distance object is in focus is f12. By not allowing a corresponding value of Conditional Expression (7) to be equal to or less than the lower limit thereof, the refractive power of the group which moves during focusing is prevented from becoming excessively weak. Therefore, it is possible to suppress the amount of movement of the group which moves during focusing. By not allowing the corresponding value of Conditional Expression (7) to be equal to or greater than the upper limit thereof, the refractive power of the group which moves during focusing is prevented from becoming excessively strong. Therefore, it is possible to suppress strictness in stop position accuracy of the group which moves during focusing.

$$0.5 < f / f 12 < 1.5 \qquad ( 7 )$$

In order to obtain more favorable characteristics, it is preferable to set any one of 0.75 or 0.9 instead of 0.5 which is the lower limit of Conditional Expression (7). Further, it is preferable to set any one of 1.3 or 1.15 instead of 1.5 which is the upper limit of Conditional Expression (7).

In the configuration in which the second lens group G2 includes an aspherical lens at a position closest to the image side, it is preferable that the imaging lens satisfies Conditional Expression (8). Here, it is assumed that a distance on the optical axis from the aperture stop St to the lens surface closest to the image side in the second lens group G2 in a state where the infinite distance object is in focus is dS2r. For example, FIG. 2 shows the distance dS2r. As shown in FIG. 2, the on-axis ray and the off-axis ray are separated in the lens closest to the image side in the second lens group G2. Therefore, by not allowing a corresponding value of Conditional Expression (8) to be equal to or less than the lower limit thereof, it is possible to further enhance the aberration correction effect of the aspherical surface. By not allowing the corresponding value of Conditional Expression (8) to be equal to or greater than the upper limit thereof, there is an advantage in reducing the total length thereof.

$$0.5 < dS 2 r / ( f \times tan ω ) < 1.5 \qquad ( 8 )$$

In order to obtain more favorable characteristics, it is preferable to set any one of 0.7 or 0.75 instead of 0.5 which is the lower limit of Conditional Expression (8). Further, it is preferable to set any one of 1.25 or 1.05 instead of 1.5 which is the upper limit of Conditional Expression (8).

It is preferable that the imaging lens satisfies Conditional Expression (9). Here, it is assumed that a distance on the optical axis from the aperture stop St to the lens surface closest to the object side in the second lens group G2 in a state where the infinite distance object is in focus is dS2f. It is assumed that the paraxial curvature radius of the lens surface closest to the object side in the second lens group G2 is R2f. For example, FIG. 2 shows the distance dS2f. By not allowing a corresponding value of Conditional Expression (9) to be equal to or less than the lower limit thereof, there is an advantage in correcting field curvature. By not allowing the corresponding value of Conditional Expression (9) to be equal to or greater than the upper limit thereof, there is an advantage in correcting spherical aberration.

$$- 0.5 < dS 2 r / R 2 f < 0 \qquad ( 9 )$$

In order to obtain more favorable characteristics, it is preferable to set any one of −0.4 or −0.33 instead of −0.5 which is the lower limit of Conditional Expression (9).

In the configuration in which the first lens group G1 consists of a negative lens and a positive lens, it is preferable that the imaging lens satisfies Conditional Expressions (10), (11), and (12) at the same time. Here, it is assumed that a refractive index of the positive lens of the first lens group G1 at a d line is N1p. It is assumed that a refractive index of the negative lens of the first lens group G1 at the d line is N1n. It is assumed that an Abbe number of the positive lens of the first lens group G1 based on the d line is v1p. It is assumed that the Abbe number of the negative lens of the first lens group G1 based on the d line is v1n. It is assumed that a partial dispersion ratio of the positive lens of the first lens group G1 between a g line and an F line is θgF1p. It is assumed that a partial dispersion ratio of the negative lens of the first lens group G1 between the g line and the F line is θgF1n.

$$\begin{matrix}0 < N 1 p - N 1 n < 0.25 & ( 10 ) \\ 0 < v 1 p - v 1 n < 40 & ( 11 ) \\ - 0.07 < θ gF 1 p - θ gF 1 n < 0 & ( 12 )\end{matrix}$$

Assuming that refractive indexes for the g line, F line, and C line of a certain lens are Ng, NF, and NC, respectively, and the partial dispersion ratio thereof between the g line and F line of the lens is θgF, θgF is defined by the following expression.

$$θ gF = ( Ng - NF ) / ( NF - NC )$$

The “d line”, “C line”, “F line”, and “g line” described in the present specification are emission lines. The wavelength of the d line is 587.56 nm (nanometers) and the wavelength of the C line is 656.27 nm (nanometers), the wavelength of F line is 486.13 nm (nanometers), and the wavelength of g line is 435.84 nm (nanometers).

By not allowing a corresponding value of Conditional Expression (10) to be equal to or less than the lower limit thereof, there is an advantage in reducing the sensitivity of optical performance with respect to manufacturing errors. By not allowing the corresponding value of Conditional Expression (10) to be equal to or greater than the upper limit thereof, there is an advantage in correcting spherical aberration. In order to obtain more favorable characteristics, it is preferable to set any one of 0.2 or 0.14 instead of 0.25 which is the upper limit of Conditional Expression (10).

By satisfying Conditional Expression (11), there is an advantage in correcting first-order spectrum. In order to obtain more favorable characteristics, it is preferable to set any one of 7.5 or 15 instead of 0 which is the lower limit of Conditional Expression (11). Further, it is preferable to set any one of 30 or 25 instead of 40 which is the upper limit of Conditional Expression (11).

By satisfying Conditional Expression (12), there is an advantage in correcting second-order spectrum. In order to obtain more favorable characteristics, it is preferable to set any one of −0.065 or −0.06 instead of −0.07 which is the lower limit of Conditional Expression (12). Further, it is preferable to set any one of −0.02 or −0.035 instead of 0 which is the upper limit of Conditional Expression (12).

In order to obtain more favorable characteristics, in a case where the imaging lens satisfies Conditional Expressions (10), (11), and (12) at the same time, it is preferable that the first lens group G1 consists of a negative lens and a positive lens in order from the object side to the image side. More specifically, it is preferable that the first lens group G1 consists of a cemented lens in which the negative lens and the positive lens are cemented in order from the object side. In order to obtain more favorable characteristics, in a case where the imaging lens satisfies Conditional Expressions (10), (11), and (12) at the same time, it is preferable that the first lens group G1 consists of a cemented lens in which a positive lens and a negative lens of which an object side surface is convex are cemented in order from the object side.

Assuming that a focal length of the third lens group G3 is f3, it is preferable that the imaging lens satisfies Conditional Expression (13). By satisfying Conditional Expression (13), the refractive power of the third lens group G3 is prevented from becoming excessively strong. Therefore, there is an advantage in suppressing fluctuation in aberrations in a case where the object distance fluctuates.

$$- 11 < f 1 / f 3 < 7.5 \qquad ( 13 )$$

In order to obtain more favorable characteristics, it is preferable to set any one of −5 or −0.46 instead of −11 which is the lower limit of Conditional Expression (13). Further, it is preferable to set any one of 5 or 0.22 instead of 7.5 which is the upper limit of Conditional Expression (13).

It is preferable that the imaging lens satisfies Conditional Expression (14). Here, it is assumed that a distance on the optical axis from the lens surface closest to the object side in the first lens group G1 to the lens surface closest to the image side in the second lens group G2 in a state where the infinite distance object is in focus is DG12. For example, FIG. 2 shows the distance DG12. By not allowing a corresponding value of Conditional Expression (14) to be equal to or less than the lower limit thereof, the spacing can be set to be advantageous for aberration correction and the workability of the lens. By not allowing the corresponding value of Conditional Expression (14) to be equal to or greater than the upper limit thereof, there is an advantage in reducing the total length thereof.

$$0.5 < DG 12 / ( f \times tan ω ) < 2 \qquad ( 14 )$$

In order to obtain more favorable characteristics, it is preferable to set any one of 0.75 or 1 instead of 0.5 which is the lower limit of Conditional Expression (14). Further, it is preferable to set any one of 1.5 or 1.35 instead of 2 which is the upper limit of Conditional Expression (14).

It is preferable that the imaging lens satisfies Conditional Expression (15). Here, it is assumed that a distance on the optical axis from the lens surface closest to the image side in the first lens group G1 to the aperture stop St is dS1r. For example, FIG. 2 shows the distance dS1r. By not allowing a corresponding value of Conditional Expression (15) to be equal to or less than the lower limit thereof, there is an advantage in correcting field curvature. By not allowing the corresponding value of Conditional Expression (15) to be equal to or greater than the upper limit thereof, there is an advantage in reducing the total length thereof.

$$0.02 < dS 1 r / f < 0.2 \qquad ( 15 )$$

In order to obtain more favorable characteristics, it is preferable to set any one of 0.025 or 0.03 instead of 0.02 which is the lower limit of Conditional Expression (15). Further, it is preferable to set any one of 0.15 or 0.13 instead of 0.2 which is the upper limit of Conditional Expression (15).

It is preferable that the imaging lens satisfies Conditional Expression (16). Here, it is assumed that a composite lateral magnification of the first lens group G1 and the second lens group G2 in a state where the infinite distance object is in focus is β12. It is assumed that a lateral magnification of the third lens group G3 in a state where the infinite distance object is in focus is β3. By not allowing a corresponding value of Conditional Expression (16) to be equal to or less than the lower limit thereof, it is possible to suppress the amount of movement of the group which moves during focusing. By not allowing the corresponding value of Conditional Expression (16) to be equal to or greater than the upper limit thereof, it is possible to suppress strictness in stop position accuracy of the group which moves during focusing.

$$0.5 < ( 1 - {β12}^{2} ) \times {β3}^{2} < 1.5 \qquad ( 16 )$$

In order to obtain more favorable characteristics, it is preferable to set any one of 0.75 or 0.85 instead of 0.5 which is the lower limit of Conditional Expression (16). Further, it is preferable to set any one of 1.4 or 1.35 instead of 1.5 which is the upper limit of Conditional Expression (16).

The example shown in FIG. 1 is an example, and various modifications can be made without departing from the scope of the technique according to the embodiment of the present disclosure. For example, the configuration of the lenses included in each lens group, the number of lenses included in each lens group, and the lens groups which move during focusing may be different from those in the example of FIG. 1.

For example, the first lens group G1 of the example of FIG. 1 may consist of a cemented lens in which a negative meniscus lens of which the object side surface is convex and a positive meniscus lens of which the object side surface is convex are cemented in order from the object side. However, in the imaging lens of the present disclosure, the first lens group G1 may be configured to consist of a negative lens which is a single lens and a positive lens which is a single lens. Further, the negative lens included in the first lens group G1 may be a biconcave lens. Furthermore, the first lens group G1 may be configured to consist of three lenses.

The second lens group G2 in the example of FIG. 1 consists of four lenses. However, in the imaging lens of the present disclosure, the second lens group G2 may be configured to consist of five or six lenses.

The third lens group G3 in the example of FIG. 1 consists of two lenses. However, in the imaging lens of the present disclosure, the third lens group G3 may be configured to consist of one lens.

During focusing, a spacing between the aperture stop St and the second lens group G2 may change, and a spacing between the second lens group G2 and the third lens group G3 may change.

The above-mentioned preferred configurations and available configurations may be optional combinations, and it is preferable to selectively adopt the configurations in accordance with required specification.

For example, in a preferred embodiment of the imaging lens of the present disclosure, the imaging lens consists of, in order from the object side to the image side, the first lens group G1, the aperture stop St, the second lens group G2, and the third lens group G3. During focusing, a spacing between at least the second lens group G2 and the third lens group G3 changes. The number of lenses included in the whole system is equal to or greater than 7 and equal to or less than 10. With such a configuration, Conditional Expression (1) and Conditional Expression (2) is satisfied.

Next, examples of the imaging lens of the present disclosure will be described, with reference to the drawings. It should be noted that the reference numerals attached to the lenses and lens groups in the cross-sectional views of each example are used independently for each example in order to avoid complication of description and drawings caused by an increase in number of digits of the reference numerals. Therefore, even in a case where common reference numerals are attached in the drawings of different examples, components do not necessarily have a common configuration.

### Example 1

FIG. 1 is a cross-sectional view of a configuration of an imaging lens of Example 1, and an illustration method and a configuration thereof are as described above. Therefore, some description is not repeated herein. The imaging lens of Example I consists of, in order from the object side to the image side, a first lens group G1 that has a positive refractive power, an aperture stop St, a second lens group G2 that has a positive refractive power, and a third lens group G3 that has a negative refractive power. During focusing from the infinite distance object to the closest object, the first lens group G1, the aperture stop St, and the second lens group G2 integrally move toward the object side. The third lens group G3 remains stationary with respect to the image plane Sim.

Regarding the imaging lens of Example 1, Table 1 shows basic lens data, Table 2 shows specification, and Table 3 shows aspherical coefficients thereof.

The table of basic lens data will be described as follows. The “Sn” column shows surface numbers in a case where the surface closest to the object side is the first surface and the number is increased one by one toward the image side. The “R” column shows a curvature radius of each surface. The “D” column shows a surface spacing between each surface and the surface adjacent to the image side on the optical axis. The “Nd” column shows a refractive index of each constituent element at the d line. The “νd” column shows an Abbe number of each constituent element based on the d line. The “θgF” column shows a partial dispersion ratio of each constituent element between the g line and the F line.

In the table of the basic lens data, the sign of the curvature radius of the surface convex toward the object side is positive, and the sign of the curvature radius of the surface convex toward the image side is negative. In a cell of a surface number of a surface corresponding to the aperture stop St, the surface number and a term of (St) are noted. A value at the bottom cell of the column of D in the table indicates a spacing between the image plane Sim and the surface closest to the image side in the table.

The table of specification shows the focal length f, the back focal length Bf, the F number FNo., and the maximum total angle of view 2ω, based on the d line. [°] in the column of the maximum total angle of view indicates the unit is degrees. Tables 1 and 2 show values in a state where the infinite distance object is in focus.

In basic lens data, a reference sign * is attached to surface numbers of aspherical surfaces, and values of the paraxial curvature radius are written into the column of the curvature radius of the aspherical surface. In Table 3, the Sn row shows surface numbers of the aspherical surfaces, and the KA and Am rows show numerical values of the aspherical coefficients for each aspherical surface. It should be noted that m of Am is an integer of 3 or more, and differs depending on the surface. For example, on the eighth surface of Example 1, m=4, 6, 8, 10, 12, 14, 16, 18, and 20. The “E±n” (n: an integer) in numerical values of the aspherical coefficients of Table 3 indicates “×10^{±n}”. KA and Am are the aspherical coefficients in the aspherical surface expression represented by the following expression.

$$Zd = C \times {h}^{2} / \{ 1 + {( 1 - KA \times {C}^{2} \times {h}^{2} )}^{1 / 2} \} + Σ Am \times {h}^{m}$$

Here,
Zd is an aspherical surface depth (a length of a perpendicular from a point on an aspherical surface at height h to a plane that is perpendicular to the optical axis Z and that is in contact with the vertex of the aspherical surface),
h is a height (a distance from the optical axis Z to the lens surface),
C is an inverse of the paraxial curvature radius,
KA and Am are aspherical coefficients, and
Σ in the aspherical surface expression means the sum with respect to m.

In the data of each table, degrees are used as a unit of an angle, and millimeters are used as a unit of a length, but appropriate different units may be used since the optical system can be used even in a case where the system is enlarged or reduced in proportion. Each of the following tables shows numerical values rounded off to predetermined decimal places.

TABLE 1
Example 1

| Sn | R | D | Nd | vd | θgF |
|---|---|---|---|---|---|
| 1 | 17.19846 | 0.920 | 1.62004 | 36.26 | 0.58800 |
| 2 | 10.12038 | 3.769 | 1.64000 | 60.20 | 0.53719 |
| 3 | 42.34013 | 4.981 | | | |
| 4(St) | ∞ | 3.950 | | | |
| 5 | −31.63718 | 1.270 | 1.60342 | 38.03 | 0.58356 |
| 6 | 16.54695 | 5.000 | 1.83481 | 42.72 | 0.56486 |
| 7 | −29.65290 | 2.250 | | | |
| *8 | −7.69859 | 2.000 | 1.68948 | 31.02 | 0.59874 |
| *9 | −10.97381 | 2.685 | | | |
| *10 | 141.15091 | 4.378 | 1.85108 | 40.12 | 0.56852 |
| *11 | −380.08659 | 5.823 | | | |
| 12 | −17.99242 | 1.000 | 1.58144 | 40.75 | 0.57757 |
| 13 | −36.33207 | 0.500 | | | |
| 14 | 223.54762 | 3.066 | 1.89190 | 37.13 | 0.57813 |
| 15 | −511.14616 | 6.596 | | | |

TABLE 2
Example 1

| | |
|---|---|
| f | 39.170 |
| Bf | 6.596 |
| FNo. | 3.6 |
| 2ω[°] | 69.30 |

TABLE 3
Example 1

| Sn | 8 | 9 | 10 | 11 |
|---|---|---|---|---|
| KA | 0.0000000E+00 | 0.0000000E+00 | 0.0000000E+00 | 0.0000000E+00 |
| A4 | 2.9084412E−04 | 2.1122555E−04 | −1.3745177E−04 | −9.4935854E−05 |
| A6 | −1.4614908E−07 | 8.6631017E−08 | 3.0220088E−07 | 5.1361077E−08 |
| A8 | −1.1609589E−08 | 5.3668048E−09 | 1.2384234E−10 | 3.4477643E−10 |
| A10 | 1.5647083E−10 | −4.4995346E−12 | 8.9845524E−13 | −3.1737706E−12 |
| A12 | 3.8152823E−13 | −4.2413584E−13 | −8.4865883E−16 | 4.0817434E−15 |
| A14 | −3.0142992E−14 | −5.8661475E−17 | −4.6373786E−19 | 1.5864915E−17 |
| A16 | 4.2796907E−17 | −2.8767272E−18 | −1.5360996E−20 | −1.5143324E−20 |
| A18 | 2.1723092E−18 | 2.0876373E−19 | −4.0024922E−22 | −4.6354302E−22 |
| A20 | −1.0625629E−20 | −8.7754928E−22 | 1.1583699E−24 | 1.2491368E−24 |

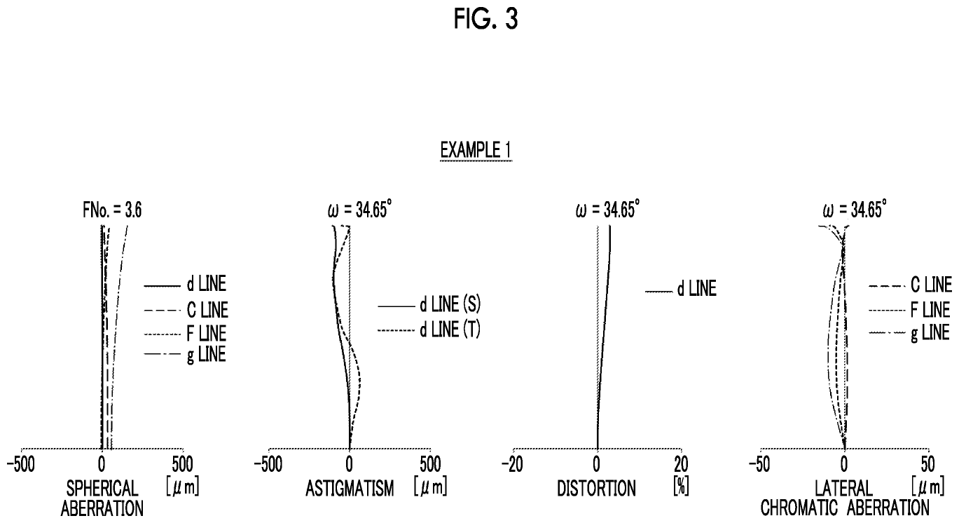

FIG. 3 shows aberration diagrams of the imaging lens according to Example 1 in a state where the infinite distance object is in focus. FIG. 3 shows spherical aberration, astigmatism, distortion, and lateral chromatic aberration, in order from the left side. In the spherical aberration diagram, aberrations at the d line, the C line, the F line, and the g line are indicated by the solid line, the long broken line, the short broken line, and the chain line, respectively. In the astigmatism diagram, aberration in the sagittal direction at the d line is indicated by the solid line, and aberration in the tangential direction at the d line is indicated by the short broken line. In the distortion diagram, aberration at the d line is indicated by a solid line. In the lateral chromatic aberration diagram, aberrations at the C line, the F line, and the g line are respectively indicated by the long broken line, the short broken line, and the chain line. In the spherical aberration diagram, a value of the F number is shown after “FNo.=”. In other aberration diagrams, the value of the maximum half angle of view is shown after “ω=”.

Symbols, meanings, description methods, and illustration methods of the respective data pieces according to Example 1 are basically similar to those in the following examples unless otherwise specified. Therefore, in the following description, repeated description will not be given.

### Example 2

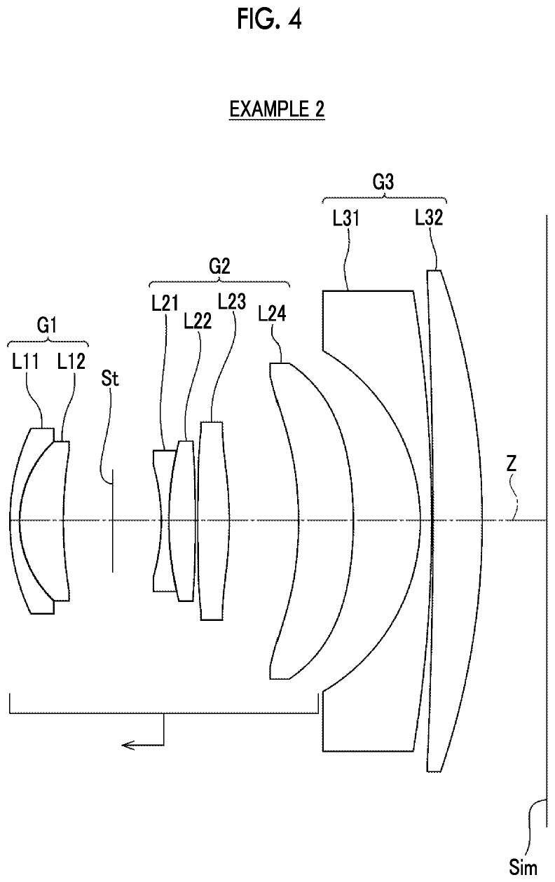

FIG. 4 is a cross-sectional view of a configuration of an imaging lens of Example 2. The imaging lens of Example 2 consists of, in order from the object side to the image side, a first lens group G1 that has a positive refractive power, an aperture stop St, a second lens group G2 that has a positive refractive power, and a third lens group G3 that has a negative refractive power. During focusing from the infinite distance object to the closest object, the first lens group G1, the aperture stop St, and the second lens group G2 integrally move toward the object side. The third lens group G3 remains stationary with respect to the image plane Sim.

The first lens group G1 consists of two lenses L11 and L12, in order from the object side to the image side. The second lens group G2 consists of four lenses L21 to L24, in order from the object side to the image side. The third lens group G3 consists of two lenses L31 and L32, in order from the object side to the image side.

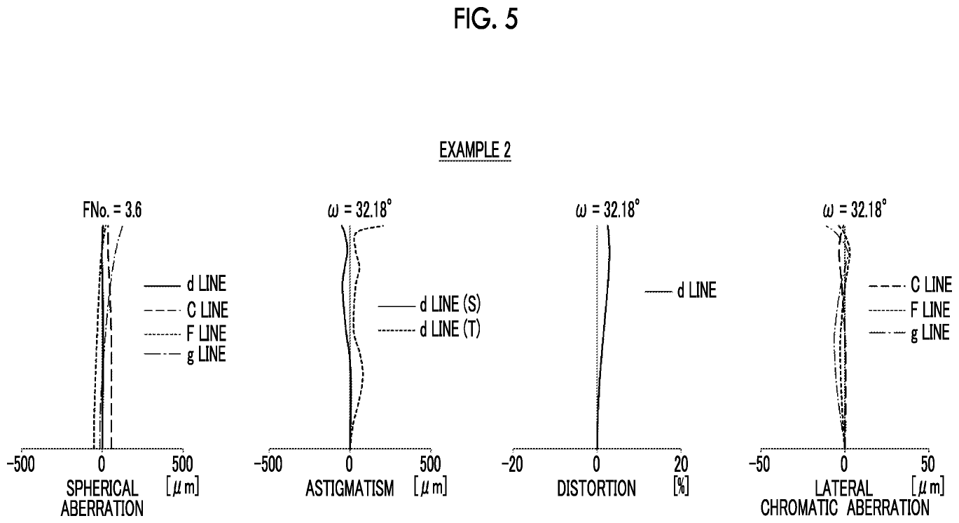

Regarding the imaging lens of Example 2, Table 4 shows basic lens data, Table 5 shows specification, Table 6 shows aspheric surface coefficients thereof, and FIG. 5 shows aberration diagrams.

TABLE 4
Example 2

| Sn | R | D | Nd | vd | θgF |
|---|---|---|---|---|---|
| 1 | 19.68511 | 0.889 | 1.59551 | 39.22 | 0.58042 |
| 2 | 10.03094 | 4.056 | 1.72916 | 54.68 | 0.54451 |
| 3 | 38.77968 | 4.561 | | | |
| 4(St) | ∞ | 4.506 | | | |
| 5 | −18.58994 | 0.710 | 1.63980 | 34.47 | 0.59233 |
| 6 | 29.16481 | 2.456 | 1.69680 | 55.53 | 0.54341 |
| 7 | −121.45393 | 0.218 | | | |
| *8 | 263.60213 | 2.927 | 1.85135 | 40.10 | 0.56954 |
| *9 | −32.94852 | 6.361 | | | |
| *10 | −34.30228 | 5.067 | 1.51633 | 64.06 | 0.53345 |
| *11 | −35.89308 | 6.207 | | | |
| 12 | −18.21635 | 1.050 | 1.48749 | 70.24 | 0.53007 |
| 13 | −133.03242 | 0.120 | | | |
| 14 | −481.05573 | 4.566 | 2.00100 | 29.13 | 0.59952 |
| 15 | −71.23898 | 5.982 | | | |

TABLE 5
Example 2

| | |
|---|---|
| f | 43.691 |
| Bf | 5.982 |
| FNo. | 3.6 |
| 2ω[°] | 64.36 |

TABLE 6
Example 2

| Sn | 8 | 9 | 10 | 11 |
|---|---|---|---|---|
| KA | 1.0000000E+00 | 1.0000000E+00 | 1.0000000E+00 | 1.0000000E+00 |
| A3 | 9.0191175E−08 | −3.4761958E−08 | 2.0487431E−07 | 1.5403208E−07 |
| A4 | 1.3384186E−05 | 5.3808203E−05 | −3.1981259E−05 | −4.4877996E−05 |
| A5 | 2.6197106E−07 | −8.1873907E−08 | 2.1531066E−07 | 1.5337084E−07 |
| A6 | 1.6202076E−07 | 1.4928541E−07 | −1.0676284E−08 | −9.5592594E−08 |
| A7 | 5.2103919E−08 | −1.6572746E−08 | 1.4290445E−08 | 1.0371178E−08 |
| A8 | −3.6078795E−09 | 1.9602489E−08 | 2.0450691E−10 | −1.0856993E−09 |
| A9 | 9.1896159E−10 | −9.6243797E−10 | 5.4223681E−12 | 5.9046063E−11 |
| A10 | −7.9960662E−11 | 3.2297720E−11 | 8.1179314E−12 | 2.6910103E−13 |
| A11 | −1.1878563E−11 | −1.5808082E−11 | −1.0337662E−12 | −4.0875680E−13 |
| A12 | 7.7395673E−13 | 4.5059402E−13 | −7.0079471E−15 | 2.4595092E−14 |
| A13 | −3.7480737E−14 | 6.7778093E−14 | 4.2738975E−15 | −1.1058284E−15 |
| A14 | 9.9227095E−15 | −2.0065563E−15 | −6.4829251E−18 | 5.5142172E−17 |
| A15 | −1.1881710E−15 | −5.5390971E−16 | −2.2077658E−17 | −1.6718859E−18 |
| A16 | 1.7815666E−16 | −4.8607073E−17 | 6.3530952E−19 | 2.1910776E−19 |
| A17 | −4.2485929E−17 | 1.5963363E−17 | 4.3239247E−20 | −3.8473854E−20 |
| A18 | 5.1379766E−18 | −7.1714879E−19 | 3.0387317E−21 | 2.3366115E−21 |
| A19 | −2.3719193E−19 | −4.7042432E−20 | −9.5822216E−22 | −1.5771057E−23 |
| A20 | −2.3808687E−21 | 4.1525953E−21 | 7.0071881E−23 | −3.8507583E−24 |
| A21 | 5.1083832E−22 | −2.4966585E−23 | −2.3111897E−24 | 1.5307614E−25 |
| A22 | −1.0429335E−23 | −3.0394304E−24 | 3.0012473E−26 | −1.8174918E−27 |

### Example 3

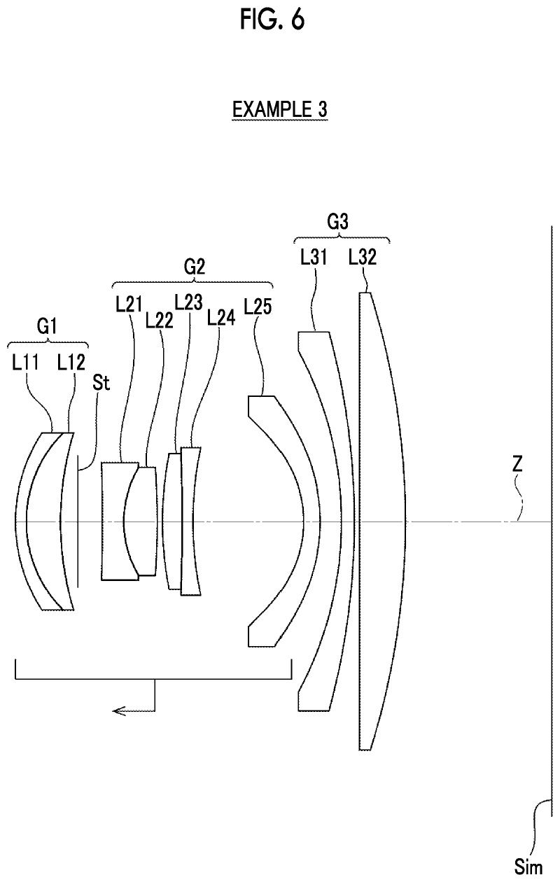

FIG. 6 is a cross-sectional view of a configuration of an imaging lens of Example 3. The imaging lens of Example 3 consists of, in order from the object side to the image side, a first lens group G1 that has a positive refractive power, an aperture stop St, a second lens group G2 that has a negative refractive power, and a third lens group G3 that has a positive refractive power. During focusing from the infinite distance object to the closest object, the first lens group G1, the aperture stop St, and the second lens group G2 integrally move toward the object side. The third lens group G3 remains stationary with respect to the image plane Sim.

The first lens group G1 consists of two lenses L11 and L12, in order from the object side to the image side. The second lens group G2 consists of five lenses L21 to L25, in order from the object side to the image side. The third lens group G3 consists of two lenses L31 and L32, in order from the object side to the image side.

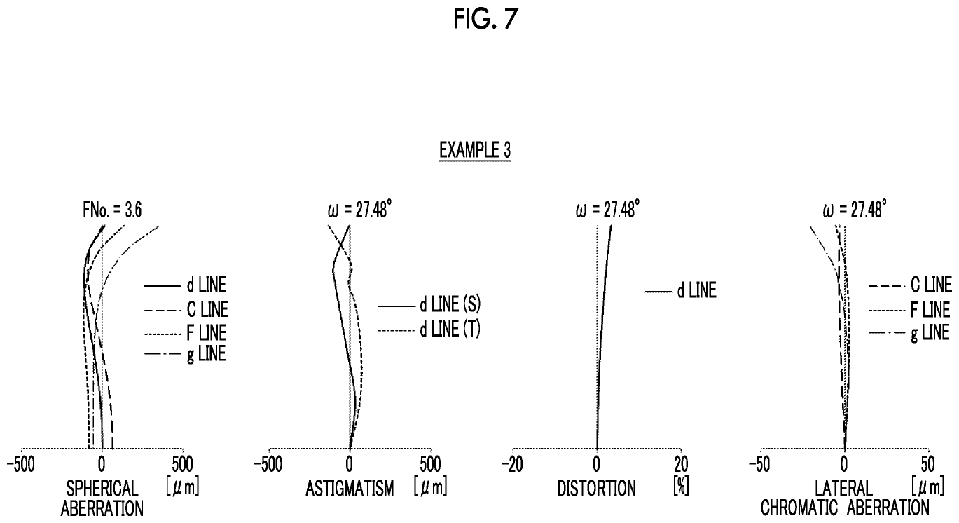

Regarding the imaging lens of Example 3, Table 7 shows basic lens data, Table 8 shows specification, Table 9 shows aspheric surface coefficients thereof, and FIG. 7 shows aberration diagrams.

TABLE 7
Example 3

| Sn | R | D | Nd | vd | θgF |
|---|---|---|---|---|---|
| 1 | 14.89571 | 1.010 | 1.80809 | 22.76 | 0.63073 |
| 2 | 11.53053 | 3.196 | 1.88300 | 39.22 | 0.57288 |
| 3 | 28.06364 | 1.623 | | | |
| 4(St) | ∞ | 2.282 | | | |
| 5 | −218.63323 | 2.000 | 1.80100 | 34.97 | 0.58642 |
| 6 | 9.72911 | 3.116 | 1.49700 | 81.54 | 0.53748 |
| 7 | −72.45726 | 0.500 | | | |
| 8 | 32.17903 | 1.840 | 1.95375 | 32.32 | 0.59056 |
| 9 | −181.86065 | 1.010 | 1.51633 | 64.14 | 0.53531 |
| 10 | 32.71795 | 10.273 | | | |
| *11 | −10.88741 | 1.531 | 1.51633 | 64.06 | 0.53345 |
| *12 | −17.38213 | 2.000 | | | |
| 13 | −33.34231 | 1.200 | 1.51742 | 52.19 | 0.55915 |
| 14 | −66.78444 | 0.500 | | | |
| 15 | −358551.77767 | 4.268 | 2.00100 | 29.13 | 0.59952 |
| 16 | −70.67099 | 13.673 | | | |

TABLE 8
Example 3

| | |
|---|---|
| f | 50.911 |
| Bf | 13.673 |
| FNo. | 3.6 |
| 2ω[°] | 54.96 |

TABLE 9
Example 3

| Sn | 11 | 12 |
|---|---|---|
| KA | 1.0000000E+00 | 1.0000000E+00 |
| A3 | 0.0000000E+00 | 0.0000000E+00 |
| A4 | −1.4272788E−04 | −9.0347068E−05 |
| A5 | 4.5775275E−05 | 2.0233970E−05 |
| A6 | −4.2457107E−06 | −1.6463777E−06 |
| A7 | −1.3675927E−07 | −1.3141754E−08 |
| A8 | 3.1190028E−08 | 7.2716265E−09 |
| A9 | 2.6913736E−09 | 3.5481615E−10 |
| A10 | −6.2367099E−11 | −3.7589068E−11 |
| A11 | −2.3038810E−11 | 4.6851638E−14 |
| A12 | −2.1218507E−12 | −1.5445871E−13 |
| A13 | 1.3121289E−13 | −6.4297081E−15 |
| A14 | 1.4537827E−14 | 7.7763996E−16 |
| A15 | 9.4327119E−16 | 1.2418402E−16 |
| A16 | 1.7400649E−17 | 6.1680941E−18 |
| A17 | 2.7981814E−18 | −2.8410228E−19 |
| A18 | −7.2125867E−19 | −6.8967984E−20 |
| A19 | −2.8067262E−19 | −4.3899327E−21 |
| A20 | 2.3523357E−20 | 4.7260388E−22 |

### Example 4

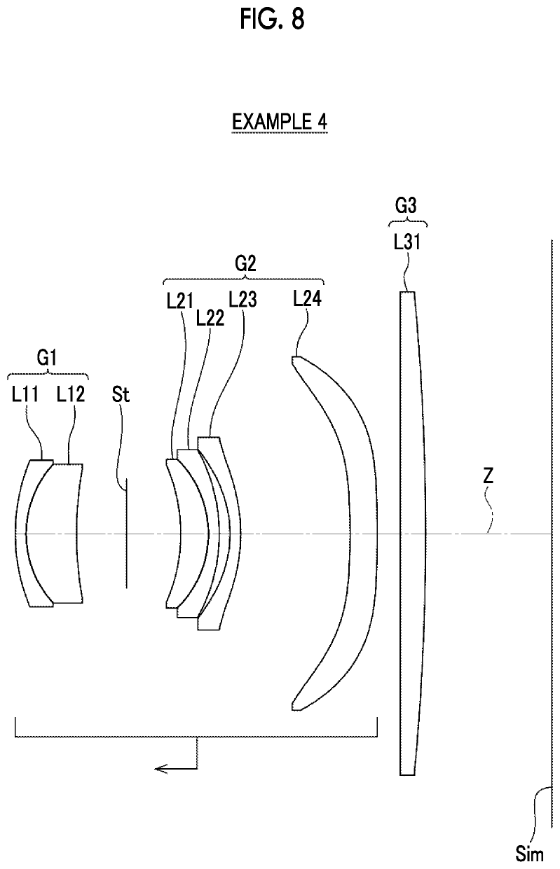

FIG. 8 is a cross-sectional view of a configuration of an imaging lens of Example 4. The imaging lens of Example 4 consists of, in order from the object side to the image side, a first lens group G1 that has a positive refractive power, an aperture stop St, a second lens group G2 that has a negative refractive power, and a third lens group G3 that has a positive refractive power. During focusing from the infinite distance object to the closest object, the first lens group G1, the aperture stop St, and the second lens group G2 integrally move toward the object side. The third lens group G3 remains stationary with respect to the image plane Sim.

The first lens group G1 consists of two lenses L11 and L12, in order from the object side to the image side. The second lens group G2 consists of four lenses L21 to L24, in order from the object side to the image side. The third lens group G3 consists of one lens L31.

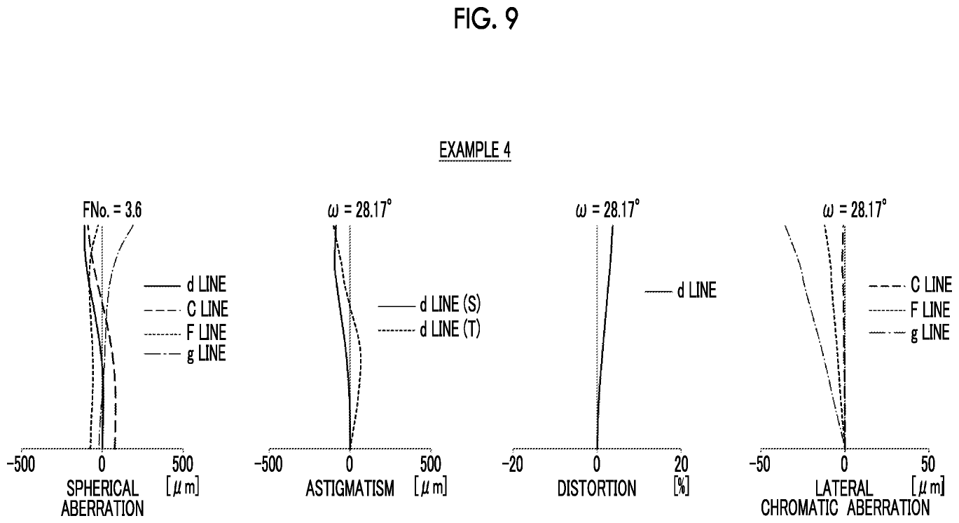

Regarding the imaging lens of Example 4, Table 10 shows basic lens data, Table 11 shows specification, Table 12 shows aspheric surface coefficients thereof, and FIG. 9 shows aberration diagrams.

TABLE 10
Example 4

| Sn | R | D | Nd | vd | θgF |
|---|---|---|---|---|---|
| 1 | 17.60506 | 1.010 | 1.69390 | 30.73 | 0.60210 |
| 2 | 9.44577 | 4.710 | 1.77079 | 50.92 | 0.54977 |
| 3 | 33.33633 | 4.674 | | | |
| 4(St) | ∞ | 5.072 | | | |
| 5 | −15.67286 | 2.580 | 1.83033 | 38.03 | 0.57732 |
| 6 | −9.65818 | 1.012 | 1.59521 | 61.34 | 0.54252 |
| 7 | −16.03265 | 1.009 | | | |
| *8 | −10.96322 | 1.000 | 1.79162 | 27.42 | 0.60992 |
| *9 | −15.69058 | 10.165 | | | |
| *10 | −74.80703 | 2.523 | 1.51600 | 64.38 | 0.53517 |
| *11 | −247.74220 | 2.179 | | | |
| 12 | 2275982.91753 | 2.361 | 1.99999 | 28.00 | 0.60309 |
| 13 | −236.43349 | 11.808 | | | |

TABLE 11
Example 4

| | |
|---|---|
| f | 49.265 |
| Bf | 11.808 |
| FNo. | 3.6 |
| 2ω[°] | 56.34 |

TABLE 12
Example 4

| Sn | 8 | 9 | 10 | 11 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.3994655E−04 | −8.7563548E−05 | −1.0657827E−04 | −1.0128587E−04 |
| A5 | 4.6993819E−05 | 3.5688529E−05 | 1.6758542E−07 | 7.6152551E−07 |
| A6 | −3.6728987E−06 | −2.7866470E−06 | 2.4331604E−08 | −2.6646639E−09 |
| A7 | −1.1223301E−07 | 5.3072289E−08 | 5.6737168E−09 | 3.2439262E−09 |
| A8 | 3.1714169E−08 | 1.3863029E−08 | 9.2505847E−11 | 2.1223621E−11 |
| A9 | 2.7960166E−09 | 3.9997495E−10 | 4.5048857E−12 | −1.7492312E−12 |
| A10 | −5.6462516E−11 | −3.2924729E−11 | 2.5426224E−13 | −5.1514147E−13 |
| A11 | −2.1833908E−11 | 5.9557974E−12 | 1.6434749E−14 | −1.7717187E−14 |
| A12 | −2.0950501E−12 | 1.4929372E−13 | 1.0485518E−15 | −1.8371854E−16 |
| A13 | 1.4939997E−13 | −4.6893987E−14 | 3.5750337E−17 | 9.6381076E−18 |
| A14 | 1.1232784E−14 | −1.0254233E−14 | −1.7693429E−18 | 2.1741685E−18 |
| A15 | −3.2390708E−16 | −9.0259613E−16 | −5.4225017E−20 | 9.3933725E−20 |
| A16 | −9.4943616E−17 | −2.3520919E−16 | −1.3783960E−20 | 4.3499760E−21 |
| A17 | −1.2167970E−17 | 1.3223329E−17 | −8.5710069E−22 | −4.3383071E−22 |
| A18 | −1.3940579E−18 | 3.3777598E−18 | −2.9845641E−23 | −3.1523274E−23 |
| A19 | −2.6937747E−19 | 2.8588273E−19 | 1.3345666E−24 | −1.6024631E−24 |
| A20 | 6.0142854E−20 | −4.0556735E−20 | 8.0854336E−26 | 1.3653000E−25 |

### Example 5

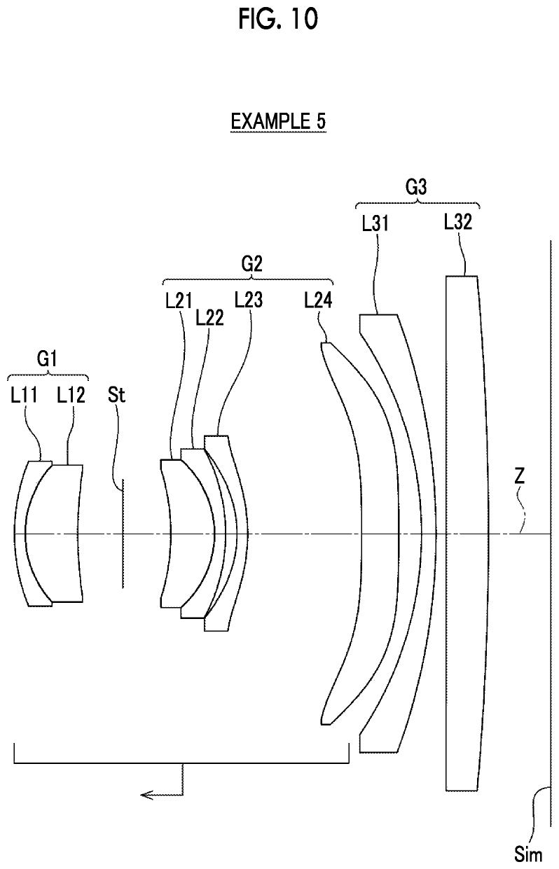

FIG. 10 is a cross-sectional view of a configuration of an imaging lens of Example 5. The imaging lens of Example 5 consists of, in order from the object side to the image side, a first lens group G1 that has a positive refractive power, an aperture stop St, a second lens group G2 that has a negative refractive power, and a third lens group G3 that has a negative refractive power. During focusing from the infinite distance object to the closest object, the first lens group G1, the aperture stop St, and the second lens group G2 integrally move toward the object side. The third lens group G3 remains stationary with respect to the image plane Sim.

The first lens group G1 consists of two lenses L11 and L12, in order from the object side to the image side. The second lens group G2 consists of four lenses L21 to L24, in order from the object side to the image side. The third lens group G3 consists of two lenses L31 and L32, in order from the object side to the image side.

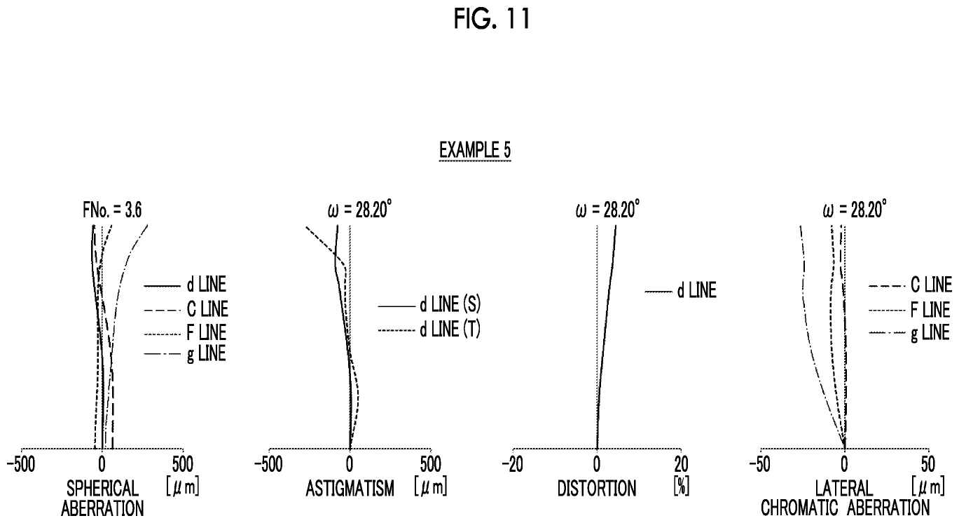

Regarding the imaging lens of Example 5, Table 13 shows basic lens data, Table 14 shows specification. Table 15 shows aspheric surface coefficients thereof, and FIG. 11 shows aberration diagrams.

TABLE 13
Example 5

| Sn | R | D | Nd | vd | θgF |
|---|---|---|---|---|---|
| 1 | 17.74380 | 1.012 | 1.71100 | 30.99 | 0.60095 |
| 2 | 9.30341 | 4.940 | 1.76460 | 51.54 | 0.54888 |
| 3 | 38.26664 | 4.235 | | | |
| 4(St) | ∞ | 4.502 | | | |
| 5 | −19.72145 | 4.093 | 1.67791 | 31.58 | 0.60021 |
| 6 | −9.09142 | 1.043 | 1.59223 | 40.72 | 0.57753 |
| 7 | −16.45048 | 1.072 | | | |
| *8 | −10.95642 | 1.000 | 1.65926 | 32.91 | 0.59684 |
| *9 | −16.56540 | 10.660 | | | |
| *10 | −150.57143 | 3.476 | 1.74074 | 53.93 | 0.54545 |
| *11 | −270.74197 | 2.131 | | | |
| 12 | −33.34303 | 1.359 | 1.90000 | 25.50 | 0.61557 |
| 13 | −59.28765 | 0.971 | | | |
| 14 | −10920.50594 | 3.957 | 1.99999 | 28.00 | 0.60309 |
| 15 | −271.34175 | 5.851 | | | |

TABLE 14
Example 5

| | |
|---|---|
| f | 48.849 |
| Bf | 5.851 |
| FNo. | 3.6 |
| 2ω[°] | 56.40 |

TABLE 15
Example 5

| Sn | 8 | 9 | 10 | 11 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.3994655E−04 | −8.7563548E−05 | −6.8169094E−05 | −6.8514440E−05 |
| A5 | 4.6881691E−05 | 3.6977747E−05 | −2.9550773E−07 | −2.9438723E−07 |
| A6 | −3.6797712E−06 | −3.2943481E−06 | −2.6092955E−09 | −1.2332190E−08 |
| A7 | −1.1250181E−07 | 8.8528401E−08 | 5.4827387E−09 | 3.0617007E−09 |
| A8 | 3.1726988E−08 | 1.9983889E−08 | 1.1500686E−10 | 5.2436162E−11 |
| A9 | 2.8009800E−09 | 4.6426156E−10 | 5.1440612E−12 | 4.6094937E−12 |
| A10 | −5.5908626E−11 | −9.8033759E−11 | 1.8719917E−13 | −2.0952761E−13 |
| A11 | −2.1747294E−11 | −3.8580826E−12 | 4.4528106E−15 | −1.7513253E−14 |
| A12 | −2.0857581E−12 | −3.8183926E−13 | 1.4499210E−16 | −8.0898568E−16 |
| A13 | 1.5009761E−13 | 1.7632345E−15 | 1.0210713E−18 | −1.9303835E−17 |
| A14 | 1.1282962E−14 | 4.2868939E−15 | −2.5811816E−18 | 6.2221369E−19 |
| A15 | −3.2078743E−16 | 7.4343693E−16 | −1.6970353E−19 | 1.2081208E−19 |
| A16 | −9.5036987E−17 | −1.6252247E−16 | −7.3315059E−21 | 1.1399414E−20 |
| A17 | −1.2135664E−17 | −1.2066486E−18 | −1.7122224E−22 | 2.9438350E−22 |
| A18 | −1.3911605E−18 | 4.9425660E−19 | 1.8846793E−23 | 9.7661309E−24 |
| A19 | −2.7079497E−19 | 6.3557776E−20 | 2.2266919E−24 | −1.0627816E−24 |
| A20 | 5.9977169E−20 | −2.9377627E−21 | −6.2620142E−26 | −5.2408732E−26 |

### Example 6

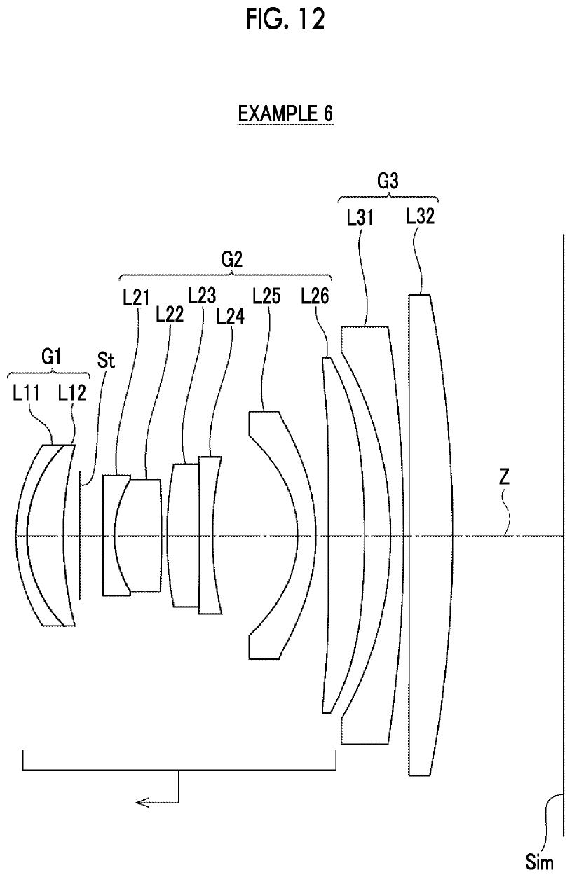

FIG. 12 is a cross-sectional view of a configuration of an imaging lens of Example 6. The imaging lens of Example 6 consists of, in order from the object side to the image side, a first lens group G1 that has a positive refractive power, an aperture stop St, a second lens group G2 that has a negative refractive power, and a third lens group G3 that has a negative refractive power. During focusing from the infinite distance object to the closest object, the first lens group G1, the aperture stop St, and the second lens group G2 integrally move toward the object side. The third lens group G3 remains stationary with respect to the image plane Sim.

The first lens group G1 consists of two lenses L11 and L12, in order from the object side to the image side. The second lens group G2 consists of six lenses L21 to L26, in order from the object side to the image side. The third lens group G3 consists of two lenses L31 and L32, in order from the object side to the image side.

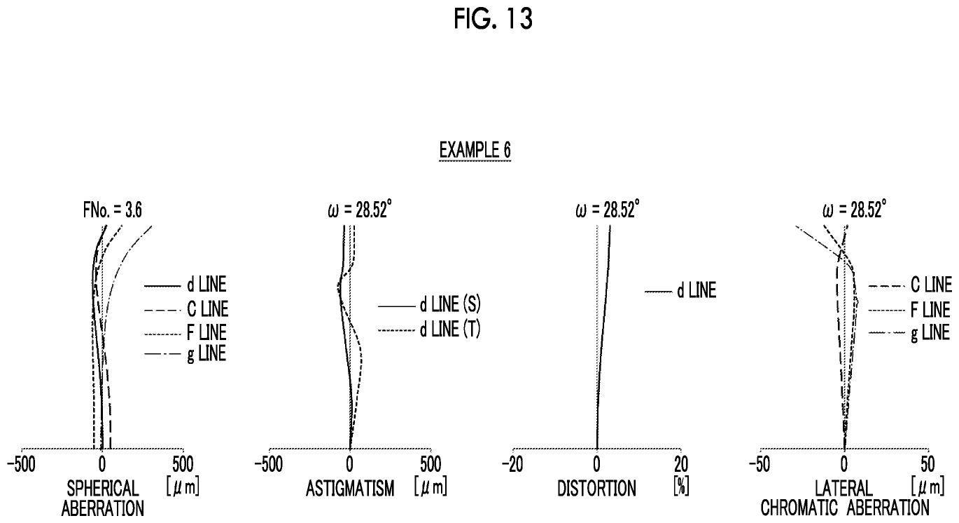

Regarding the imaging lens of Example 6, Table 16 shows basic lens data, Table 17 shows specifications. Table 18 shows aspherical coefficients thereof, and FIG. 13 shows aberration diagrams.

TABLE 16
Example 6

| Sn | R | D | Nd | vd | θgF |
|---|---|---|---|---|---|
| 1 | 14.95485 | 1.010 | 1.80809 | 22.76 | 0.63073 |
| 2 | 11.59724 | 3.316 | 1.88300 | 39.22 | 0.57288 |
| 3 | 31.69347 | 1.500 | | | |
| 4(St) | ∞ | 2.114 | | | |
| 5 | −1678.73867 | 1.065 | 1.80100 | 34.97 | 0.58642 |
| 6 | 9.62524 | 4.292 | 1.49700 | 81.54 | 0.53748 |
| 7 | −126.61997 | 0.500 | | | |
| 8 | 34.13778 | 2.983 | 1.95375 | 32.32 | 0.59056 |
| 9 | −283.49260 | 1.182 | 1.51633 | 64.14 | 0.53531 |
| 10 | 30.96218 | 7.723 | | | |
| *11 | −10.88117 | 1.661 | 1.51633 | 64.06 | 0.53345 |
| *12 | −17.92363 | 1.131 | | | |
| *13 | 897.87364 | 3.319 | 1.73050 | 53.94 | 0.54560 |
| *14 | −75.71851 | 2.370 | | | |
| 15 | −33.34350 | 1.204 | 1.51742 | 52.15 | 0.55911 |
| 16 | −125.09035 | 0.500 | | | |
| 17 | −16225.42960 | 3.969 | 2.00100 | 29.13 | 0.59952 |
| 18 | −115.23079 | 10.142 | | | |

TABLE 17
Example 6

| | |
|---|---|
| f | 48.831 |
| Bf | 10.142 |
| FNo. | 3.6 |
| 2ω[°] | 57.04 |

TABLE 18
Example 6

| Sn | 11 | 12 | 13 | 14 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.3994655E−04 | −8.7563548E−05 | −5.3730347E−06 | −8.6223667E−06 |
| A5 | 4.6533138E−05 | 2.5718450E−05 | −7.7178139E−07 | −3.9311737E−07 |
| A6 | −3.9047817E−06 | −1.7826894E−06 | −4.6842481E−08 | −3.2060723E−08 |
| A7 | −1.3418143E−07 | −3.8665031E−08 | 2.7222574E−09 | −7.3803224E−10 |
| A8 | 2.8957951E−08 | 7.5564155E−09 | 2.8254611E−11 | −7.4336380E−12 |
| A9 | 2.4140054E−09 | 3.5648402E−10 | 3.7287900E−12 | 1.4370809E−12 |
| A10 | −8.4851446E−11 | −3.8389741E−11 | 2.3855341E−13 | 1.5291656E−13 |
| A11 | −2.4597299E−11 | 7.3001544E−13 | 9.1903750E−15 | −5.4837675E−15 |
| A12 | −2.1919797E−12 | −1.5562517E−13 | 3.0004441E−16 | −1.8630509E−16 |
| A13 | 1.3156984E−13 | −5.0512171E−15 | 2.3698342E−18 | 1.1850329E−17 |
| A14 | 1.5209800E−14 | 9.5103582E−16 | −2.4466923E−18 | 1.7396894E−18 |
| A15 | 1.0550449E−15 | 1.3470143E−16 | −1.4234212E−19 | 2.0147564E−19 |
| A16 | 3.0459991E−17 | 5.7117142E−18 | −4.0260751E−21 | 9.9236976E−21 |
| A17 | 3.9533613E−18 | −4.6211786E−19 | 7.2994597E−23 | 6.0959484E−23 |
| A18 | −6.6866907E−19 | −8.9956948E−20 | 8.3490061E−24 | −1.0247438E−23 |
| A19 | −2.8278068E−19 | −5.4792730E−21 | 1.3096628E−24 | −1.4535104E−24 |
| A20 | 2.5393701E−20 | 6.7923700E−22 | −9.1176197E−26 | −1.2744508E−25 |

### Example 7

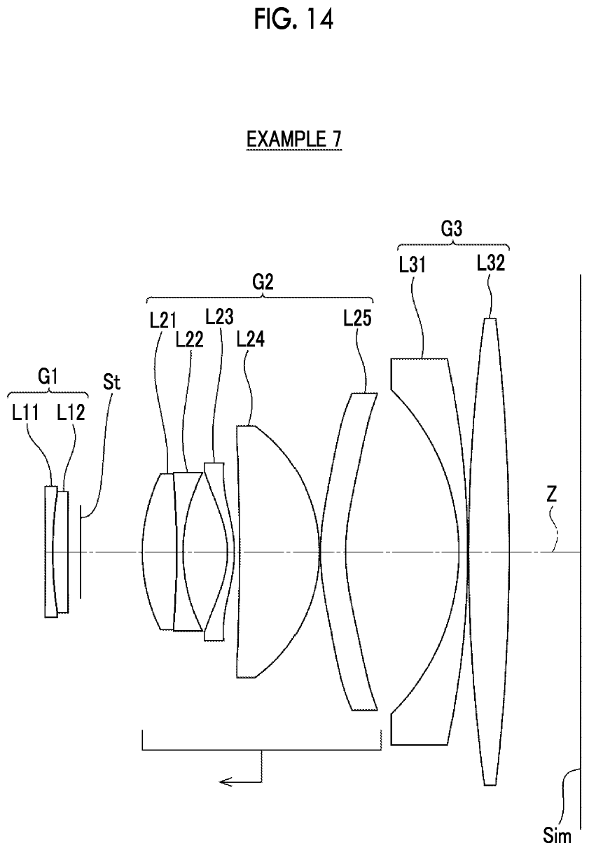

FIG. 14 is a cross-sectional view of a configuration of an imaging lens of Example 7. The imaging lens of Example 7 consists of, in order from the object side to the image side, a first lens group G1 that has a positive refractive power, an aperture stop St, a second lens group G2 that has a positive refractive power, and a third lens group G3 that has a negative refractive power. During focusing from the infinite distance object to the closest object, the second lens group G2 moves toward the object side, and the first lens group G1, the aperture stop St, and the third lens group G3 remain stationary with respect to the image plane Sim.

The first lens group G1 consists of two lenses L11 and L12, in order from the object side to the image side. The second lens group G2 consists of five lenses L21 to L25, in order from the object side to the image side. The third lens group G3 consists of two lenses L31 and L32, in order from the object side to the image side.

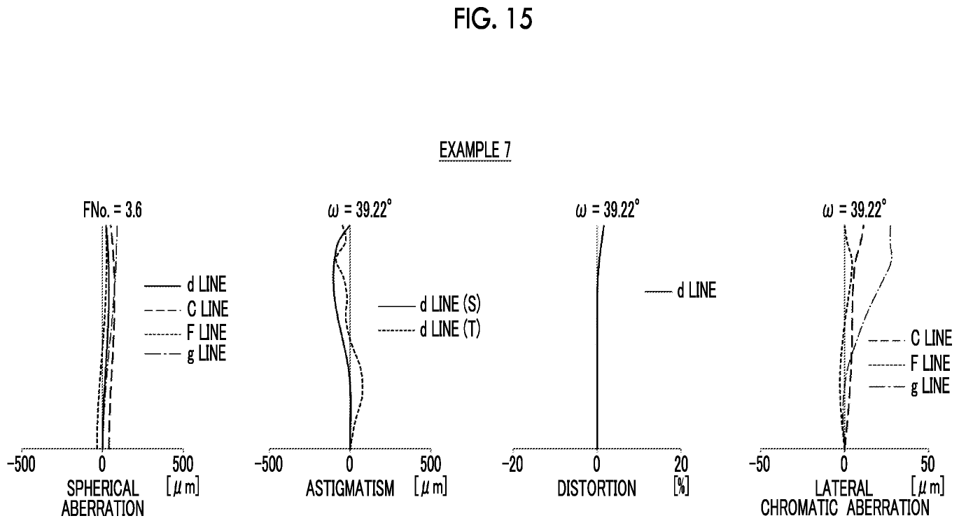

Regarding the imaging lens of Example 7, Table 19 shows basic lens data, Table 20 shows specifications, Table 21 shows aspherical coefficients thereof, and FIG. 15 shows aberration diagrams.

TABLE 19
Example 7

| Sn | R | D | Nd | vd | θgF |
|---|---|---|---|---|---|
| 1 | −473.47809 | 0.735 | 1.71350 | 29.33 | 0.60000 |
| 2 | 40.52199 | 1.500 | 1.88300 | 39.22 | 0.57288 |
| 3 | 965.97540 | 1.250 | | | |
| 4(St) | ∞ | 6.130 | | | |
| 5 | 17.23046 | 3.402 | 1.88300 | 39.22 | 0.57288 |
| 6 | −89.84092 | 0.635 | 1.64279 | 34.09 | 0.58867 |
| 7 | 16.66219 | 4.414 | | | |
| *8 | −8.90819 | 0.675 | 1.80301 | 25.53 | 0.61531 |
| *9 | −12.46090 | 0.510 | | | |
| 10 | −250.19955 | 7.877 | 1.66439 | 59.46 | 0.54026 |
| 11 | −15.31979 | 0.100 | | | |
| *12 | 21.09066 | 2.500 | 1.76450 | 49.10 | 0.55289 |
| *13 | 19.91608 | 11.226 | | | |
| 14 | −22.48832 | 0.875 | 1.85025 | 30.05 | 0.59797 |
| 15 | −89.98829 | 0.100 | | | |
| 16 | 170.30051 | 4.020 | 1.88300 | 39.22 | 0.57288 |
| 17 | −198.91407 | 7.073 | | | |

TABLE 20
Example 7

| | |
|---|---|
| f | 32.965 |
| Bf | 7.073 |
| FNo. | 3.6 |
| 2ω[°] | 78.44 |

TABLE 21
Example 7

| Sn | 8 | 9 | 12 | 13 |
|---|---|---|---|---|
| KA | 1.0000000E+00 | 1.0000000E+00 | 1.0000000E+00 | 1.0000000E+00 |
| A4 | 5.4876153E−04 | 4.5087995E−04 | −1.4412786E−04 | −1.4452076E−04 |
| A6 | 1.4268764E−06 | 5.7842391E−07 | 3.7193169E−07 | 3.4435630E−07 |
| A8 | −2.8104553E−08 | −9.2019460E−09 | 8.4800504E−10 | 6.9124453E−10 |
| A10 | 4.9031829E−10 | −1.0791537E−10 | −6.3579827E−12 | −6.3056204E−12 |
| A12 | −2.6659289E−12 | 2.7416215E−13 | 1.3223662E−15 | 2.7955668E−15 |
| A14 | −1.5757015E−15 | 1.2724155E−14 | 6.6816311E−17 | 7.6555652E−17 |
| A16 | 1.4452845E−16 | 8.7941207E−17 | −1.4637539E−19 | −1.8628217E−19 |
| A18 | 7.1441029E−18 | −1.3495743E−18 | 0.0000000E+00 | 0.0000000E+00 |

### Example 8

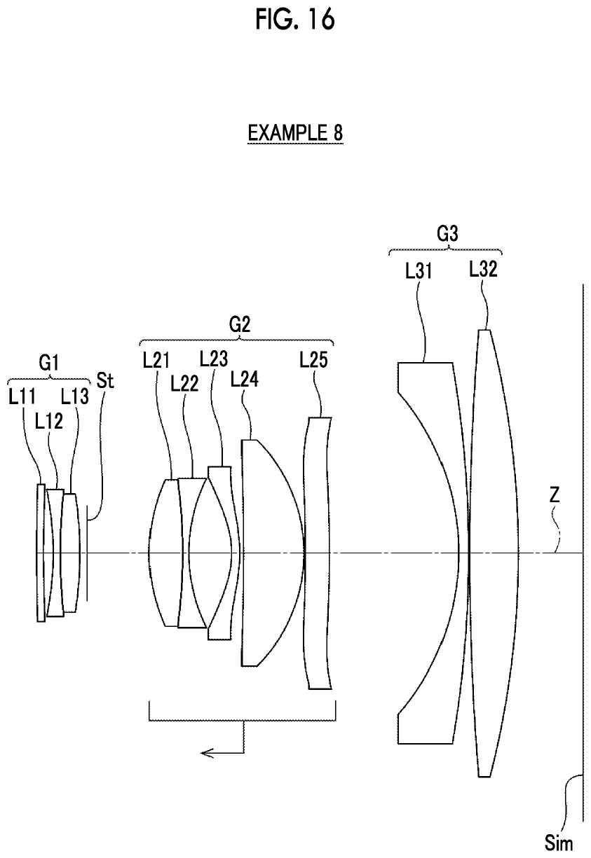

FIG. 16 is a cross-sectional view of a configuration of the imaging lens of Example 8. The imaging lens of Example 8 consists of, in order from the object side to the image side, a first lens group G1 that has a positive refractive power, an aperture stop St, a second lens group G2 that has a positive refractive power, and a third lens group G3 that has a negative refractive power. During focusing from the infinite distance object to the closest object, the second lens group G2 moves toward the object side, and the first lens group G1, the aperture stop St, and the third lens group G3 remain stationary with respect to the image plane Sim.

The first lens group G1 consists of three lenses L11 to L13, in order from the object side to the image side. The second lens group G2 consists of five lenses L21 to L25, in order from the object side to the image side. The third lens group G3 consists of two lenses L31 and L32, in order from the object side to the image side.

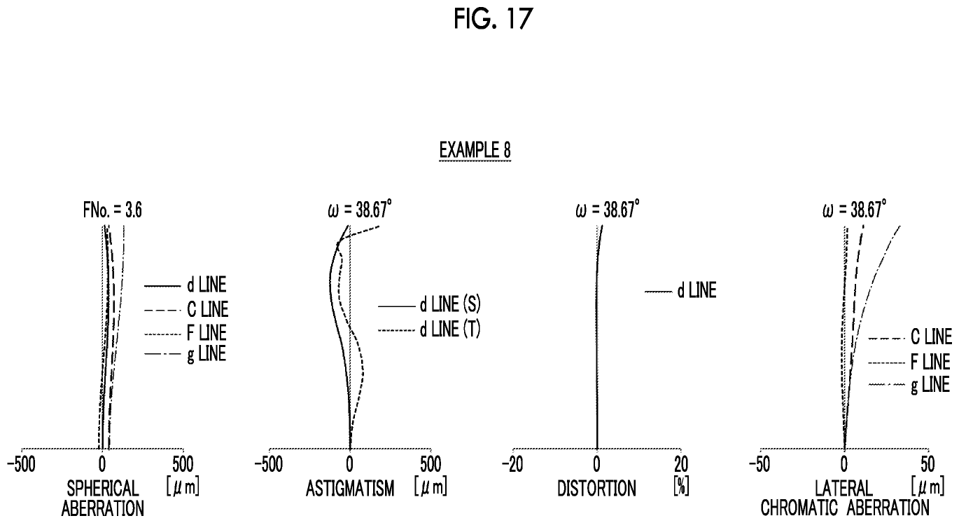

Regarding the imaging lens of Example 8, Table 22 shows basic lens data, Table 23 shows specifications and variable surface spacings, Table 24 shows aspherical coefficients thereof, and FIG. 17 shows aberration diagrams.

TABLE 22
Example 8

| Sn | R | D | Nd | vd | θgF |
|---|---|---|---|---|---|
| 1 | 297.50332 | 0.700 | 1.48749 | 70.32 | 0.52917 |
| 2 | 151.96754 | 1.000 | | | |
| 3 | −31.31421 | 0.735 | 1.67270 | 32.18 | 0.59733 |
| 4 | 59.86854 | 2.000 | 1.88300 | 39.22 | 0.57288 |
| 5 | −39.30896 | 0.750 | | | |
| 6(St) | ∞ | 6.314 | | | |
| 7 | 18.01723 | 3.409 | 1.88300 | 39.22 | 0.57288 |
| 8 | −55.98630 | 0.635 | 1.62588 | 35.72 | 0.58880 |
| 9 | 16.96150 | 4.390 | | | |
| *10 | −9.09622 | 0.831 | 1.80301 | 25.53 | 0.61531 |
| *11 | −14.70004 | 0.363 | | | |
| 12 | −339.33868 | 6.210 | 1.72188 | 56.63 | 0.54002 |
| 13 | −16.27352 | 0.100 | | | |
| *14 | −1163.22650 | 2.500 | 1.43599 | 67.48 | 0.52494 |
| *15 | −171.46525 | 13.210 | | | |
| 16 | −24.99979 | 1.000 | 1.90714 | 33.10 | 0.58886 |
| 17 | −114.71453 | 0.100 | | | |
| 18 | 280.77440 | 5.000 | 1.88300 | 39.22 | 0.57288 |
| 19 | −90.75729 | 6.642 | | | |

TABLE 23
Example 8

| | |
|---|---|
| f | 33.761 |
| Bf | 6.642 |
| FNo. | 3.6 |
| 2ω[°] | 77.34 |

TABLE 24
Example 8

| Sn | 10 | 11 |
|---|---|---|
| KA | 1.0000000E+00 | −1.5872803E−01 |
| A4 | 5.6320957E−04 | 4.1884206E−04 |
| A6 | −2.0452826E−06 | −2.7888070E−06 |
| A8 | 7.1309391E−09 | 1.5351500E−08 |
| A10 | 3.7223342E−10 | 2.7673803E−11 |
| A12 | −1.5588048E−12 | −1.1360137E−12 |
| A14 | 7.2333023E−14 | −1.4226319E−15 |
| A16 | −2.3240405E−15 | 9.9767526E−17 |
| A18 | 2.2905827E−17 | −3.4177677E−19 |
| Sn | 14 | 15 |
| KA | 1.0000000E+00 | 1.0000000E+00 |
| A4 | −6.6148475E−05 | −2.6367795E−05 |
| A6 | 7.1790965E−07 | 3.2129851E−07 |
| A8 | −1.1502209E−09 | −1.9400933E−10 |
| A10 | −1.5690492E−12 | 8.3615932E−13 |
| A12 | −1.4288534E−15 | −1.0051007E−14 |

### Example 9

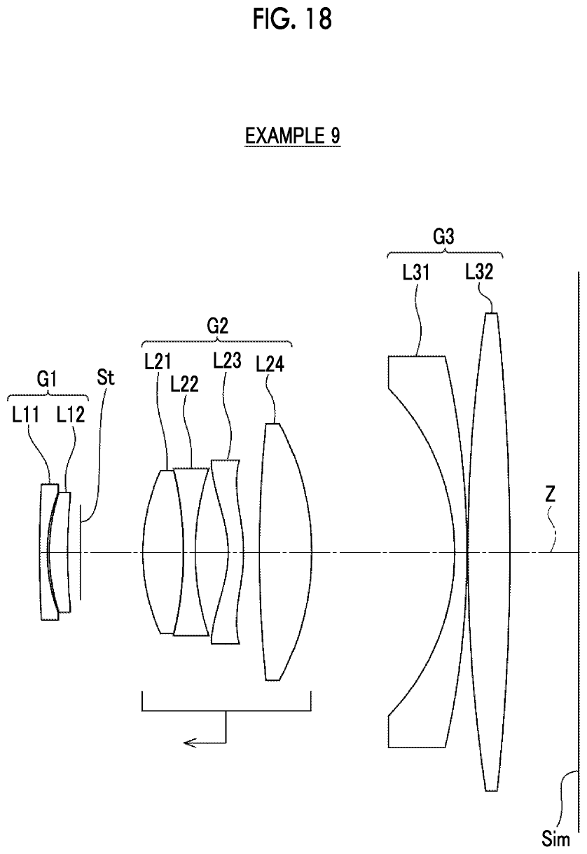

FIG. 18 is a cross-sectional view of a configuration of the imaging lens of Example 9. The imaging lens of Example 9 consists of, in order from the object side to the image side, a first lens group G1 that has a negative refractive power, an aperture stop St, a second lens group G2 that has a positive refractive power, and a third lens group G3 that has a negative refractive power. During focusing from the infinite distance object to the closest object, the second lens group G2 moves toward the object side, and the first lens group G1, the aperture stop St, and the third lens group G3 remain stationary with respect to the image plane Sim.

The first lens group G1 consists of two lenses L11 and L12, in order from the object side to the image side. The second lens group G2 consists of four lenses L21 to L24, in order from the object side to the image side. The third lens group G3 consists of two lenses L31 and L32, in order from the object side to the image side.

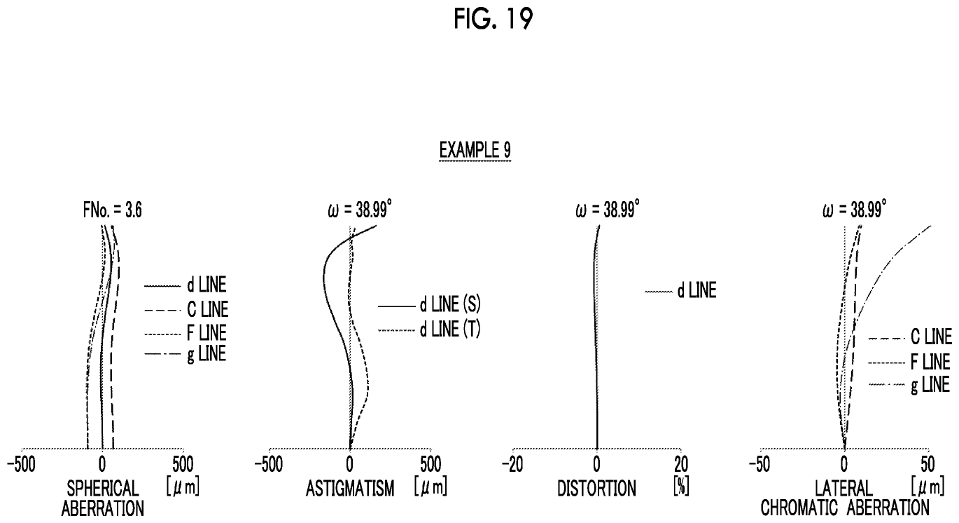

Regarding the imaging lens of Example 9, Table 25 shows basic lens data, Table 26 shows specifications, Table 27 shows aspherical coefficients thereof, and FIG. 19 shows aberration diagrams.

TABLE 25
Example 9

| Sn | R | D | Nd | vd | θgF |
|---|---|---|---|---|---|
| *1 | 109.44362 | 0.753 | 1.68948 | 31.02 | 0.59874 |
| *2 | 16.59289 | 0.200 | | | |
| 3 | 18.52521 | 1.798 | 1.91650 | 31.60 | 0.59117 |
| 4 | 53.86647 | 1.250 | | | |
| 5(St) | ∞ | 6.140 | | | |
| 6 | 19.07970 | 4.000 | 1.88300 | 39.22 | 0.57288 |
| 7 | −33.62189 | 1.145 | 1.69895 | 30.13 | 0.60298 |
| 8 | 25.52515 | 3.248 | | | |
| *9 | −10.66303 | 1.500 | 1.80301 | 25.53 | 0.61531 |
| *10 | −15.71497 | 1.560 | | | |
| 11 | 120.06667 | 5.089 | 1.77535 | 50.30 | 0.55004 |
| 12 | −26.66030 | 14.044 | | | |
| 13 | −22.96384 | 1.200 | 1.85025 | 30.05 | 0.59797 |
| 14 | −86.09314 | 0.100 | | | |
| 15 | 156.16975 | 4.124 | 1.88300 | 39.22 | 0.57288 |
| 16 | −218.68420 | 6.761 | | | |

TABLE 26
Example 9

| | |
|---|---|
| f | 33.589 |
| Bf | 6.761 |
| FNo. | 3.6 |
| 2ω[°] | 77.98 |

TABLE 27
Example 9

| Sn | 1 | 2 |
|---|---|---|
| KA | 1.0000000E+00 | 1.0000000E+00 |
| A4 | −3.4772634E−05 | −4.2113873E−05 |
| A6 | 1.2858645E−06 | 2.0500981E−06 |
| A8 | −2.2859478E−08 | −4.8021533E−08 |
| A10 | 1.6870353E−10 | 4.6913708E−10 |
| Sn | 9 | 10 |
| KA | 1.0000000E+00 | 1.0000000E+00 |
| A4 | 5.2002728E−04 | 4.2869338E−04 |
| A6 | 3.7715522E−07 | −4.9785719E−08 |
| A8 | −3.2519041E−08 | −1.2961676E−08 |
| A10 | 3.9321407E−10 | −1.6062831E−11 |
| A12 | −2.8514724E−12 | 1.2489769E−12 |
| A14 | 3.4925368E−14 | 4.8441739E−15 |
| A16 | −2.0310519E−16 | −1.5434907E−16 |
| A18 | −9.9244973E−22 | 5.6899341E−19 |

Tables 28 and 29 show the corresponding values of Conditional Expressions (1) to (16) of the imaging lenses of Examples 1 to 9. Here, regarding Conditional Expression (9), only the corresponding values of examples satisfying Conditional Expression (9) are shown. Preferable ranges of the conditional expressions may be set by using the corresponding values of the examples shown in Tables 28 and 29 as the upper or lower limits of the conditional expressions.

TABLE 28

| Expression | | | | | | |
|---|---|---|---|---|---|---|
| Number | | Example 1 | Example 2 | Example 3 | Example 4 | Example 5 |
| (1) | TL/(f × tanω) | 1.7621 | 1.8164 | 1.8298 | 1.8324 | 1.8397 |
| (2) | Bf/(f × tanω) | 0.2414 | 0.2188 | 0.5007 | 0.4322 | 0.2144 |
| (3) | f1/f23 | 0.0605 | −0.2056 | −0.5445 | −0.2985 | −0.5953 |
| (4) | f/f1 | 0.9595 | 1.1699 | 1.6943 | 1.3647 | 1.4043 |
| (5) | TL/f | 1.2303 | 1.1370 | 0.9825 | 1.0170 | 1.0297 |
| (6) | Dexp/(f × tanω) | 1.1082 | 1.2000 | 1.4659 | 1.3705 | 1.1343 |
| (7) | f/f12 | 1.1141 | 1.1388 | 0.9374 | 0.9500 | 1.0988 |
| (8) | dS2r/(f × tanω) | 0.7954 | 0.8091 | 0.8517 | 0.8855 | 0.9868 |
| (9) | dS2f/R2f | −0.1248 | −0.2424 | −0.0104 | −0.3236 | −0.2283 |
| (10) | N1p − N1n | 0.0200 | 0.1336 | 0.0749 | 0.0769 | 0.0536 |
| (11) | ν1p − ν1n | 23.9503 | 15.4592 | 16.4572 | 20.1862 | 20.5495 |
| (12) | θgF1p − θgF1n | −0.0505 | −0.0359 | −0.0579 | −0.0523 | −0.0521 |
| (13) | f1/f3 | −0.4105 | −0.3731 | 0.2088 | 0.1527 | −0.2690 |
| (14) | DG12/(f × tanω) | 1.1408 | 1.1609 | 1.0377 | 1.2342 | 1.3175 |
| (15) | dS1r/f | 0.1272 | 0.1044 | 0.0319 | 0.0949 | 0.0867 |
| (16) | (1 − β12²) × β3² | 1.2412 | 1.2970 | 0.8787 | 0.9025 | 1.2074 |

TABLE 29

| Expression | | | | | |
|---|---|---|---|---|---|
| Number | | Example 6 | Example 7 | Example 8 | Example 9 |
| (1) | TL/(f × tanω) | 1.8282 | 1.9386 | 2.0434 | 1.9345 |
| (2) | Bf/(f × tanω) | 0.3715 | 0.2585 | 0.2428 | 0.2470 |
| (3) | f1/f23 | −0.6080 | 16.3671 | 7.0616 | −13.8850 |
| (4) | f/f1 | 1.7700 | 0.0582 | 0.1236 | −0.0775 |
| (5) | TL/f | 1.0235 | 1.6085 | 1.6554 | 1.5753 |
| (6) | Dexp/(f × tanω) | 1.3676 | 1.3800 | 1.5347 | 1.3616 |
| (7) | f/f12 | 1.0645 | 1.1402 | 1.1840 | 1.1863 |
| (8) | dS2r/(f × tanω) | 0.9787 | 0.9754 | 1.0179 | 0.8802 |
| (9) | dS2f/R2f | −0.0013 | — | — | — |
| (10) | N1p-N1n | 0.0749 | 0.1695 | — | 0.2270 |
| (11) | vlp-vln | 16.4572 | 9.8924 | — | 0.5807 |
| (12) | θgFlp-θgFln | −0.0579 | −0.0271 | — | −0.0076 |
| (13) | f1/f3 | −0.0650 | −10.2771 | −3.9416 | 7.2670 |
| (14) | DGl2/(f × tanω) | 1.1626 | 1.0869 | 1.0946 | 1.0612 |
| (15) | dS1r/f | 0.0307 | 0.0379 | 0.0222 | 0.0372 |
| (16) | (1 − βl2²) × β3² | 1.1331 | 4.3414 | 1.4020 | 1.4072 |

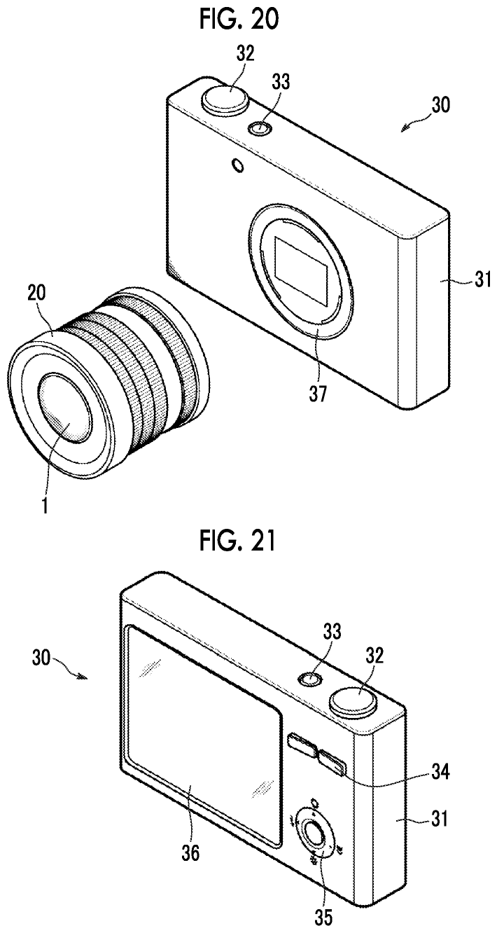

Next, an imaging apparatus according to an embodiment of the present disclosure will be described. FIGS. 20 and 21 are external views of a camera 30 which is the imaging apparatus according to the embodiment of the present disclosure. FIG. 20 is a perspective view of the camera 30 viewed from a front side, and FIG. 21 is a perspective view of the camera 30 viewed from a rear side. The camera 30 is a so-called mirrorless type digital camera, and the interchangeable lens 20 can be removably attached thereto. The interchangeable lens 20 is configured to include the imaging lens 1, which is housed in a lens barrel, according to an embodiment of the present disclosure.

The camera 30 comprises a camera body 31, and a shutter button 32 and a power button 33 are provided on an upper surface of the camera body 31. Further, an operating part 34, an operating part 35, and a display unit 36 are provided on a rear surface of the camera body 31. The display unit 36 is able to display a captured image and an image within an angle of view before imaging.

An imaging aperture, through which light from an imaging target is incident, is provided at the center on the front surface of the camera body 31. A mount 37 is provided at a position corresponding to the imaging aperture. The interchangeable lens 20 is mounted on the camera body 31 with the mount 37 interposed therebetween.

In the camera body 31, there are provided an imaging element, a signal processing circuit, a storage medium, and the like. The imaging element such as a charge coupled device (CCD) or a complementary metal oxide semiconductor (CMOS) outputs a captured image signal based on a subject image which is formed through the interchangeable lens 20. The signal processing circuit generates an image through processing of the captured image signal which is output from the imaging element. The storage medium stores the generated image. The camera 30 is able to capture a still image or a video in a case where the shutter button 32 is pressed, and is able to store image data, which is obtained through imaging, in the storage medium.

The technique of the present disclosure has been hitherto described through embodiments and examples, but the technique of the present disclosure is not limited to the above-mentioned embodiments and examples, and may be modified into various forms. For example, values such as the curvature radius, the surface spacing, the refractive index, the Abbe number, and the aspherical coefficient of each lens are not limited to the values shown in the examples, and different values may be used therefor.

Further, the imaging apparatus according to the embodiment of the present disclosure is not limited to the above example, and may be modified into various forms such as a camera other than the mirrorless type, a film camera, a video camera, and a security camera.

Regarding the above-mentioned embodiments and examples, the following Supplementary Notes will be further disclosed.

### Supplementary Note 1

An imaging lens consisting of, in order from an object side to an image side:
a first lens group;
a stop;
a second lens group; and
a third lens group,
in which at least a spacing between the second lens group and the third lens group changes during focusing,
the number of lenses included in a whole system is equal to or greater than 7 and equal to or less than 10, and
assuming that
   a sum of a back focal length of the whole system in terms of an air-equivalent distance and a distance on an optical axis from a lens surface closest to the object side in the first lens group to a lens surface closest to the image side in the third lens group in a state where an infinite distance object is in focus is TL,
   a focal length of the whole system in a state where an infinite distance object is in focus is f, and
   a maximum half angle of view in a state where the infinite distance object is in focus is ω, and
   the back focal length of the whole system in terms of the air-equivalent distance in a state where the infinite distance object is in focus is Bf,

Conditional Expressions (1) and (2) are satisfied, which are represented by

$$\begin{matrix}0.6 < TL / ( f \times tan ω ) < 3 , and & ( 1 ) \\ 0.06 < Bf / ( f \times tan ω ) < 0.9 . & ( 2 )\end{matrix}$$

### Supplementary Note 2

The imaging lens according to Supplementary Note 1,
in which assuming that
   a focal length of the first lens group is f1, and
   a composite focal length of the second lens group and the third lens group in a state where the infinite distance object is in focus is f23,

Conditional Expression (3) is satisfied, which is represented by

$$- 1 < f 1 / f 23 < 0.1 . \qquad ( 3 )$$

### Supplementary Note 3

The imaging lens according to Supplementary Note 1 or 2, in which the first lens group, the stop, and the second lens group move integrally during focusing.

### Supplementary Note 4

The imaging lens according to any one of Supplementary Notes 1 to 3, in which the first lens group includes, successively in order from a position closest to the object side, a negative lens of which a surface on the object side is convex, and a positive lens.

### Supplementary Note 5

The imaging lens according to any one of Supplementary Notes 1 to 4, in which assuming that a focal length of the first lens group is f1, Conditional Expression (4) is satisfied, which is represented by

$$- 0.5 < f / f 1 < 2.5 . \qquad ( 4 )$$

### Supplementary Note 6

The imaging lens according to any one of Supplementary Notes 1 to 5, in which Conditional Expression (5) is satisfied, which is represented by

$$0 < TL / f < 1.7 . \qquad ( 5 )$$

### Supplementary Note 7

The imaging lens according to any one of Supplementary Notes 1 to 6, in which the first lens group consists of a cemented lens in which a negative lens, of which an object side surface is convex, and a positive lens are cemented in order from the object side.

### Supplementary Note 8

The imaging lens according to any one of Supplementary Notes 1 to 7, comprising a positive lens that is closest to the image side in the third lens group.

### Supplementary Note 9

The imaging lens according to any one of Supplementary Notes 1 to 8,
in which assuming that
   a distance on the optical axis from a paraxial exit pupil position to an image plane in a state where the infinite distance object is in focus is Dexp, and
   Dexp is calculated using an air-equivalent distance for an optical member having no refractive power in a case where the optical member is disposed between the image plane and the paraxial exit pupil position,

Conditional Expression (6) is satisfied, which is represented by

$$0.8 < Dexp / ( f \times tan ω ) < 2. \qquad ( 6 )$$

### Supplementary Note 10

The imaging lens according to any one of Supplementary Notes 1 to 9, in which assuming that a composite focal length of the first lens group and the second lens group in a state where the infinite distance object is in focus is f12, Conditional Expression (7) is satisfied, which is represented by

$$0.5 < f / f 12 < 1.5 . \qquad ( 7 )$$

### Supplementary Note 11

The imaging lens according to any one of Supplementary Notes 1 to 10, in which a lens surface closest to the object side in the second lens group is concave, and a lens surface closest to the image side in the second lens group is convex.

### Supplementary Note 12

The imaging lens according to any one of Supplementary Notes 1 to 11,
in which the second lens group includes an aspherical lens at a position closest to the image side, and
assuming that a distance on the optical axis from the stop to a lens surface closest to the image side in the second lens group in a state where the infinite distance object is in focus is dS2r, Conditional Expression (8) is satisfied, which is represented by

$$0.5 < dS 2 r / ( f \times tan ω ) < 1.5 . \qquad ( 8 )$$

### Supplementary Note 13

The imaging lens according to any one of Supplementary Notes 1 to 12,
in which assuming that
   a distance on the optical axis from the stop to a lens surface closest to the object side in the second lens group in a state where the infinite distance object is in focus is dS2f, and
   a paraxial curvature radius of a lens surface closest to the object side in the second lens group is R2f,

Conditional Expression (9) is satisfied, which is represented by

$$- 0.5 < dS 2 r / R 2 f < 0. \qquad ( 9 )$$

### Supplementary Note 14

The imaging lens according to any one of Supplementary Notes 1 to 13,
in which the first lens group consists of a negative lens and a positive lens, and
assuming that
   a refractive index of the positive lens of the first lens group at a d line is N1p,
   a refractive index of the negative lens of the first lens group at the d line is N1n,
   an Abbe number of the positive lens of the first lens group based on the d line is v1p,
   an Abbe number of the negative lens of the first lens group based on the d line is v1n,
   a partial dispersion ratio of the positive lens of the first lens group between a g line and an F line is θgF1p, and
   a partial dispersion ratio of the negative lens of the first lens group between the g line and the F line is θgF1n,

Conditional Expressions (10), (11), and (12) are satisfied, which are represented by

$$\begin{matrix}0.1 < N 1 p - N 1 n < 0.25 , & ( 10 ) \\ 0 < v 1 p - v 1 n < 40 , and & ( 11 ) \\ - 0.07 < θ gF 1 p - θ gF 1 n < 0. & ( 12 )\end{matrix}$$

### Supplementary Note 15

The imaging lens according to any one of Supplementary Notes 1 to 14, in which the third lens group consists of, in order from the object side to the image side, a negative lens and a positive lens.

### Supplementary Note 16

The imaging lens according to any one of Supplementary Notes 1 to 15,
in which assuming that
   a focal length of the first lens group is f1, and
   a focal length of the third lens group is f3,
   Conditional Expression (13) is satisfied, which is represented by

$$- 11 < f 1 / f 3 < 7.5 . \qquad ( 13 )$$

### Supplementary Note 17

The imaging lens according to any one of Supplementary Notes 1 to 16, in which assuming that a distance on the optical axis from a lens surface closest to the object side in the first lens group to a lens surface closest to the image side in the second lens group in a state where the infinite distance object is in focus is DG12, Conditional Expression (14) is satisfied, which is represented by

$$0.5 < DG 12 / ( f \times tan ω ) < 2. \qquad ( 14 )$$

### Supplementary Note 18

The imaging lens according to any one of Supplementary Notes 1 to 17, in which

Conditional Expression (1-1) is satisfied, which is represented by

$$0.85 < TL / ( f \times tan ω ) < 2.1 . \qquad ( 1 - 1 )$$

### Supplementary Note 19

The imaging lens according to any one of Supplementary Notes 1 to 18, in which Conditional Expression (2-1) is satisfied, which is represented by

$$0.1 < Bf / ( f \times tan ω ) < 0.51 . \qquad ( 2 - 1 )$$

### Supplementary Note 20

An imaging apparatus comprising the imaging lens according to any one of Supplementary Notes 1 to 19.

What is claimed is:

1. An imaging lens consisting of, in order from an object side to an image side:
a first lens group;
a stop;
a second lens group; and
a third lens group,
wherein at least a spacing between the second lens group and the third lens group changes during focusing,
the number of lenses included in the imaging lens is equal to or greater than 7 and equal to or less than 10, and
assuming that
a sum of a back focal length of the imaging lens in terms of an air-equivalent distance and a distance on an optical axis from a lens surface closest to the object side in the first lens group to a lens surface closest to the image side in the third lens group in a state where an infinite distance object is in focus is TL,
a focal length of the imaging lens in a state where the infinite distance object is in focus is f,
a maximum half angle of view in a state where the infinite distance object is in focus is ω, and
the back focal length of the imaging lens in terms of the air-equivalent distance in a state where the infinite distance object is in focus is Bf,
Conditional Expressions (1) and (2) are satisfied, which are represented by
$$\begin{matrix}0.6 < TL / ( f \times tan ω ) < 3 , and & ( 1 ) \\ 0.06 < Bf / ( f \times tan ω ) < 0.9 . & ( 2 )\end{matrix}$$

2. The imaging lens according to claim 1,
wherein assuming that
a focal length of the first lens group is f1, and
a composite focal length of the second lens group and the third lens group in a state where the infinite distance object is in focus is f23,
Conditional Expression (3) is satisfied, which is represented by
$$- 1 < f 1 / f 23 < 0.1 . \qquad ( 3 )$$

3. The imaging lens according to claim 2,
wherein the first lens group, the stop, and the second lens group move integrally during focusing.

4. The imaging lens according to claim 3,
wherein the first lens group includes, successively in order from a position closest to the object side, a negative lens of which a surface on the object side is convex, and a positive lens.

5. The imaging lens according to claim 1,
wherein Conditional Expression (1-1) is satisfied, which is represented by
$$0.85 < TL / ( f \times tan ω ) < 2.1 . \qquad ( 1 - 1 )$$

6. The imaging lens according to claim 5,
wherein Conditional Expression (2-1) is satisfied, which is represented by
$$0.1 < Bf / ( f \times tan ω ) < 0.51 . \qquad ( 2 - 1 )$$

7. The imaging lens according to claim 1,
wherein assuming that a focal length of the first lens group is f1, Conditional Expression (4) is satisfied, which is represented by
$$- 0.5 < f / f 1 < 2.5 . \qquad ( 4 )$$

8. The imaging lens according to claim 1,
wherein Conditional Expression (5) is satisfied, which is represented by
$$0 < TL / f < 1.7 . \qquad ( 5 )$$

9. The imaging lens according to claim 1,
wherein the first lens group consists of a cemented lens in which a negative lens, of which an object side surface is convex, and a positive lens are cemented in order from the object side.

10. The imaging lens according to claim 1, comprising a positive lens at a position closest to the image side in the third lens group.

11. The imaging lens according to claim 1,
wherein assuming that
a distance on the optical axis from a paraxial exit pupil position to an image plane in a state where the infinite distance object is in focus is Dexp, and
Dexp is calculated using an air-equivalent distance for an optical member having no refractive power in a case where the optical member is disposed between the image plane and the paraxial exit pupil position,
Conditional Expression (6) is satisfied, which is represented by
$$0.8 < Dexp / ( f \times tan ω ) < 2. \qquad ( 6 )$$

12. The imaging lens according to claim 1,
wherein assuming that a composite focal length of the first lens group and the second lens group in a state where the infinite distance object is in focus is f12, Conditional Expression (7) is satisfied, which is represented by
$$0.5 < f / f 12 < 1.5 . \qquad ( 7 )$$

13. The imaging lens according to claim 1,
wherein a lens surface closest to the object side in the second lens group is concave, and a lens surface closest to the image side in the second lens group is convex.

14. The imaging lens according to claim 1,
wherein the second lens group includes an aspherical lens at a position closest to the image side, and
assuming that a distance on the optical axis from the stop to a lens surface closest to the image side in the second lens group in a state where the infinite distance object is in focus is dS2r, Conditional Expression (8) is satisfied, which is represented by
$$0.5 < dS 2 r / ( f \times tan ω ) < 1.5 . \qquad ( 8 )$$

15. The imaging lens according to claim 14,
wherein assuming that
a distance on the optical axis from the stop to a lens surface closest to the object side in the second lens group in a state where the infinite distance object is in focus is dS2f, and
a paraxial curvature radius of a lens surface closest to the object side in the second lens group is R2f,
Conditional Expression (9) is satisfied, which is represented by
$$- 0.5 < dS 2 r / R 2 f < 0. \qquad ( 9 )$$

16. The imaging lens according to claim 9,
wherein assuming that
a refractive index of the positive lens of the first lens group at a d line is N1p,
a refractive index of the negative lens of the first lens group at the d line is N1n,
an Abbe number of the positive lens of the first lens group based on the d line is v1p,
an Abbe number of the negative lens of the first lens group based on the d line is v1n,
a partial dispersion ratio of the positive lens of the first lens group between a g line and an F line is θgF1p, and
a partial dispersion ratio of the negative lens of the first lens group between the g line and the F line is θgF1n,
Conditional Expressions (10), (11), and (12) are satisfied, which are represented by
$$\begin{matrix}0 < N 1 p - N 1 n < 0.25 , & ( 10 ) \\ 0 < v 1 p - v 1 n < 40 , and & ( 11 ) \\ - 0.07 < θ gF 1 p - θ gF 1 n < 0. & ( 12 )\end{matrix}$$

17. The imaging lens according to claim 1,
wherein the third lens group consists of, in order from the object side to the image side, a negative lens and a positive lens.

18. The imaging lens according to claim 1,
wherein assuming that
a focal length of the first lens group is f1, and
a focal length of the third lens group is f3,
Conditional Expression (13) is satisfied, which is represented by
$$- 11 < f 1 / f 3 < 7.5 . \qquad ( 13 )$$

19. The imaging lens according to claim 1,
wherein assuming that a distance on the optical axis from a lens surface closest to the object side in the first lens group to a lens surface closest to the image side in the second lens group in a state where the infinite distance object is in focus is DG12, Conditional Expression (14) is satisfied, which is represented by
$$0.5 < DG 12 / ( f \times tan ω ) < 2. \qquad ( 14 )$$

20. An imaging apparatus comprising the imaging lens according to claim 1.
